(19) United States
(12) Patent Application Publication
(10) Pub. No.: US 2025/0142510 A1
(43) Pub. Date: May 1, 2025

(54) AMF NODE, UAV, SMF NODE, METHOD, AND NON-TRANSITORY COMPUTER READABLE MEDIUM

(71) Applicant: NEC Corporation, Minato-ku, Tokyo (JP)

(72) Inventors: Tsuyoshi Takakura, Tokyo (JP); Toshiyuki Tamura, Tokyo (JP)

(73) Assignee: NEC Corporation, Minato-ku, Tokyo (JP)

(21) Appl. No.: 18/683,274

(22) PCT Filed: Sep. 29, 2022
(86) PCT No.: PCT/JP2022/036394

§ 371 Date: Feb. 13, 2024

(30) Foreign Application Priority Data
Sep. 29, 2021 (JP) 2021-160146

(51) Int. Cl. H04W 60/06; H04W 12/06; H04W 76/30

(52) U.S. Cl. CPC H04W 60/06; H04W 12/06; H04W 76/30

(57) ABSTRACT

An object is to provide an apparatus, a method, and a program that can appropriately handle a collision between a UUAA procedure and other mobility or session management procedures. An Access and Mobility Management Function (AMF) node initiates a UAV Authentication and Authorization (UUAA-MM) procedure, receive a DEREGISTRATION REQUEST message in a UE-initiated de-registration procedure from an Uncrewed Aerial Vehicle (UAV), abort the UUAA-MM procedure in response to the receipt of the DEREGISTRATION REQUEST message, and proceed with the UE-initiated de-registration procedure when the AMF node receives the DEREGISTRATION REQUEST message. This allows the AMF to appropriately handle a collision between, for example, the UUAA procedure and other mobility management procedures.

### TECHNICAL FIELD

The present disclosure relates to a cellular network, and in particular to authentication and authorization of a drone system.

### BACKGROUND ART

The 5G system (5GS) connects a radio terminal (user equipment (UE) or an Uncrewed Aerial Vehicle (UAV)) to a Data Network (DN). Hereinafter, a UE can be interpreted as UAV and vice versa. Connectivity services between the UE and the DN are supported by one or more Protocol Data Unit (PDU) sessions (see, for example, Non Patent Literature 1-3). A PDU session is an association, session, or connection between the UE and the DN. A PDU session is used to provide a PDU connectivity service (i.e., an exchange of PDUs between the UE and the DN). A PDU session is established between the UE and a User Plane Function (UPF) (i.e., PDU session anchor) to which the DN is connected. In terms of data transfer, a PDU session consists of a tunnel (N9 tunnel) in the 5G core network (5GC), a tunnel (N3 tunnel) between the 5GC and an Access Network (AN), and one or more radio bearers.

Non Patent Literature 2 and Non Patent Literature 3 specify the PDU session establishment procedure, the PDU session modification, and PDU session release procedures. More specifically, the PDU session establishment procedure is described, for example, in Chapter 4.3.2 of Non Patent Literature 2 and Chapter 6.4.1 of Non Patent Literature 3. The PDU session modification procedure is described, for example, in Chapter 4.3.3 of Non Patent Literature 2 and Chapter 6.4.2 of Non Patent Literature 3. The PDU session release procedure is described, for example, in Chapter 4.3.4 of Non Patent Literature 2 and Chapter 6.4.3 of Non Patent Literature 3.

The 5GS also supports network slicing (see, for example, Non Patent Literature 1 to 3, especially Section 5.15 of Non Patent Literature 1). Network slicing uses Network Function Virtualization (NFV) and software-defined networking (SDN) technologies, thereby creating multiple virtualized logical networks on top of physical networks. Each virtualized logical network is called a network slice. A network slice provides specific network capabilities and network characteristics. In order to form a single network slice, a network slice instance (NSI) is defined as a set of network function (NF) instances, resources (e.g., computer processing resources, storage, and networking resources), and an access network (AN) (at least one of a Next Generation Radio Access Network (NG-RAN) and a Non-3GPP Interworking Function (N3IWF)).

A network slice is identified by an identifier known as Single Network Slice Selection Assistance Information (S-NSSAI). The S-NSSAI consists of a Slice/Service type (SST) and a Slice Differentiator (SD). The SST refers to the expected network slice behavior in terms of features and services. The SD is optional information and complements the SST to differentiate amongst multiple network slices of the same Slice/Service type.

An S-NSSAI can have standard values or non-standard values. Currently, standard SST values 1, 2, 3, and 4 are associated respectively with enhanced Mobile Broad Band (eMBB), Ultra Reliable and Low Latency Communication (URLLC), Massive Internet of Things (MIOT), and Vehicle to Everything (V2X) slice types. A non-standard value of an S-NSSAI identifies a single network slice within a specific Public Land Mobile Network (PLMN). In other words, non-standard SST values are PLMN-specific values, and associated with the PLMN ID of a PLMN that has assigned them. Each S-NSSAI ensures network isolation by selecting a particular NSI. A NSI may be selected via different S-NSSAIs. An S-NSSAI may be associated with different NSIs. A network slice may be uniquely identified by an S-NSSAI.

There are two types of S-NSSAI, known as S-NSSAI and Mapped S-NSSAI. An S-NSSAI identifies a network slice served by a Public Land Mobile Network (PLMN) in which a UE is registered. A Mapped S-NSSAI may be an S-NSSAI of a Home PLMN (HPLMN) that is mapped to (associated with, or applicable to) an S-NSSAI that identifies a network slice of a roaming network when a UE is roaming, and also an S-NSSAI that is included in the subscription information of the UE. Thereafter, S-NSSAI and Mapped S-NSSAI may be collectively referred to as simply S-NSSAI in this specification.

Meanwhile, Network Slice Selection Assistance Information (NSSAI) means a set of S-NSSAIs. Accordingly, one or more S-NSSAIs can be included in one NSSAI. There are multiple types of NSSAI, known as Configured NSSAI, Requested NSSAI, Allowed NSSAI, Rejected NSSAI, and Pending NSSAI.

A Configured NSSAI includes one or more S-NSSAIs each applicable to one or more PLMNs. For example, The Configured NSSAI can include S-NSSAI and Mapped S-NSSAI.

The Configured NSSAI is configured by a Serving PLMN and is applied to the Serving PLMN. Alternatively, the Configured NSSAI may be a Default Configured NSSAI. The Default Configured NSSAI is configured by the Home PLMN (HPLMN) and applies to any PLMNs for which no specific Configured NSSAI has been provided. For example, a radio terminal (User Equipment (UE)) is provisioned with the Default Configured NSSAI from a Unified Data Management (UDM) of the HPLMN via an Access and Mobility Management Function (AMF).

A Requested NSSAI is signaled by a UE to a network in, for example, a registration procedure, allowing the network to determine a serving AMF, at least one network slice and at least one NSIs, for this UE. The Requested NSSAI can include the S-NSSAI and the Mapped S-NSSAIs.

An allowed NSSAI is provided to a UE by a Serving PLMN and indicates one or more S-NSSAIs that the UE can use in the current Registration Area of the Serving PLMN. The Allowed NSSAI can include the S-NSSAI and the Mapped S-NSSAI. The Allowed NSSAI is determined by an AMF of the Serving PLMN, for example, during a registration procedure. Accordingly, the Allowed NSSAI is signaled to the UE by the network (i.e., AMF) and stored in (non-volatile) memories of both the AMF and the UE.

A Rejected NSSAI includes one or more S-NSSAIs rejected by the current (or serving) PLMN. When the UE is roaming, the Rejected NSSAI includes the S-NSSAI of the Home PLMN (HPLMN). The Rejected NSSAI may be referred to as rejected S-NSSAIs. A S-NSSAI is rejected throughout the current PLMN or rejected in the current registration area. If an AMF rejects any of one or more S-NSSAIs included in the Requested NSSAI, for example, in a registration procedure of a UE, it includes them in the Rejected NSSAI. The Rejected NSSAI is signaled to the UE by the network (i.e., AMF) and stored in (non-volatile) memories of both the AMF and the UE.

The Extended Rejected NSSAI includes one or more S-NSSAIs rejected by the current (or serving) PLMN. The Extended Rejected NSSAI can include an S-NSSAI and a Mapped S-NSSAI.

A Pending NSSAI indicates one or more S-NSSAIs for which Network Slice-Specific Authentication and Authorization (NSSAA)) is pending. The Pending NSSAI can include S-NSSAI and Mapped S-NSSAI. A Serving PLMN shall perform NSSAA for S-NSSAIs of the HPLMN which are subject to NSSAA based on subscription information. In order to perform NSSAA, an AMF invokes an Extensible Authentication Protocol (EAP)-based authorization procedure. The EAP-based authentication procedure takes a relatively long time to obtain its outcome. Accordingly, whilst the AMF determines an Allowed NSSAI as described above during a registration procedure of a UE, it does not include S-NSSAIs subject to NSSAA in the Allowed NSSAI, but instead them in the Pending NSSAI. The Pending NSSAI is signaled to the UE by the network (i.e., AMF) and stored in (non-volatile) memories of both the AMF and the UE.

An AMF manages a UE context for a UE in Registration Management (RM)-REGISTERED state. The UE context may be referred to as, but is not limited to, a Mobility Management (MM) context. The UE context may include one or more of the Allowed NSSAI, Rejected NSSAI, Extended Rejected NSSAI, and Pending NSSAI described above. On the other hand, the UE manages a UE NSSAI configuration, which includes the Configured NSSAI, Allowed NSSAI, Rejected NSSAI, Extended Rejected NSSAI, and Pending NSSAI described above. The UE NSSAI configuration is stored in a non-volatile memory in the UE (Mobile Equipment (ME) except Universal Subscriber Identity Module (USIM)). The memory or memory area where the UE NSSAI configuration is stored is referred to as NSSAI storage.

Section 5.15.10 of Non Patent Literature 1 and Section 4.2.9 of Non Patent Literature 2 specify the Network Slice-Specific Authentication and Authorization (NSSAA). More specifically, section 5.15.10 of Non Patent Literature 1 and section 4.2.9.2 of Non Patent Literature 2 describe the NSSAA. Section 5.15.10 of Non Patent Literature 1 and Section 4.2.9.3 of Non Patent Literature 2 describe the re-authentication and re-authorization triggered by an Authentication, Authorization and Accounting (AAA) server (AAA-S). Section 5.15.10 of Non Patent Literature 1 and Section 4.2.9.4 of Non Patent Literature 2 describe the revocation of Slice-Specific Authorization triggered by an AAA server (AAA-S).

Section 5.2 of Non Patent Literature 4 specifies UAV Authentication and Authorization (UUAA). More specifically, Sections 5.2.2, 5.2.3 and 5.2.4 of Non Patent Literature 4 describe UAV Authentication and Authorization (UUAA). Section 5.2.5 of Non Patent Literature 4 describes Authorization for C2 communication to implement C2 communication. Hereinafter, UAV Authentication and Authorization (UUAA) can be interpreted as Authorization for C2 communication and vice versa.

The Third Generation Partnership Project (3GPP) SA2 working group has begun working on standardizing 5G architecture enhancements for UAVs to achieve drone systems utilizing mobile communication (see, for example, Non Patent Literature 4). The 5G architecture enhancements specify the following enhancements: the function to authenticate and authorize UAVs by a UAS Service Supplier (USS) in mobility management. This UAV authentication and authorization is referred to as UUAA-MM. The 5G architecture enhancements also specify the following enhancement function: UAV authentication and authorization by the USS in session management. This UAV authentication and authorization is referred to as UUAA-SM. UUAA-MM and UUAA-SM may be referred to as UUAA. The 5G architecture enhancements also specify the following enhancement: C2 communication authorization function to implement C2 communication.

The UAV must be authenticated and authorized before it can use the UAS (Uncrewed Aerial System) Service. The UAS Service means communication with USS, C2 communication, remote identification of UAVs, and connectivity for location and tracking of UAVs to provide safe and efficient airspace utilization services.

The UE executes either a UUAA-MM procedure or a UUAA-SM procedure to undergo the authentication and authorization.

The UUAA-MM is executed when the registration procedure is executed based on the operator policy. The AMF executes the UUAA-MM procedure if Access and Mobility subscriber data of the UAV includes aerial UE subscription and a Civil Aviation Administration (CAA)-Level UAV ID is included in a registration request message. The CAA-Level-UAV ID is issued by the USS, which performs drone flight management, for example, and is used to identify the UAV.

When the UUAA-MM is not executed, the UUAA-SM is executed at the time when the PDU session establishment procedure (PDU session establishment and PDU session modification) is executed. The SMF executes the UUAA-SM procedure when DNN and/or S-NSSAI of the PDU session establishment are supported by the UAS service and the PDU session establishment procedure includes the CAA-Level UAV ID.

The UE must obtain C2 (Command and Control) communication authorization to enable operations based on the C2 communication. The C2 communication means a user plane link for propagating messages containing information about UAV operational commands and control from a UAV controller (UAV-C) or UTM (UAS Traffic Management) to the UAV and for reporting telemetry data from the UAV to the UAV controller or UTM. The UAV controller of the UAS enables a drone pilot to control a UAV. The UTM is a system that enables flying UAVs to safely and efficiently share airspace with other users.

The C2 communication authorization may be performed in the UUAA-SM procedure described above or after UAV authentication and authorization have been performed. When the C2 communication authorization is executed after the UAV authentication and authorization, the UE executes a PDU session modification procedure including the CAA-Level UAV ID and C2 authorization information. The SMF executes a C2 communication authorization procedure when the DNN and/or S-NSSAI of the PDU session to be modified are supported by the UAS service and the PDU session modification procedure includes the CAA-Level UAV ID.

In the UUAA-MM, UUAA-SM, and C2 communication authorization described above, after each procedure is initiated, exchanges of authentication and/or authorization information between the USS and the UE are performed multiple times, and the UE is notified of the results of authentication and authorization. In the UUAA-MM procedure, a DL NAS TRANSPORT message transmitted by the AMF to the UE includes the result of authentication and authorization. In the UUAA-SM procedure, a PDU session accept message transmitted by the SMF to the UE includes the result of authentication and authorization.

### CITATION LIST

### Non Patent Literature

Non Patent Literature 1: 3GPP TS 23.501 V17.2.0 (2021-09) “3rd Generation Partnership Project; Technical Specification Group Services and System Aspects; System architecture for the 5G System (5GS); Stage 2 (Release 17)”, June 2021
Non Patent Literature 2: 3GPP TS 23.502 V17.2.0 (2021-09) “3rd Generation Partnership Project; Technical Specification Group Services and System Aspects; Procedures for the 5G System (5GS); Stage 2 (Release 17)”, June 2021
Non Patent Literature 3: 3GPP TS 24.501 V17.4.1 (2021-09) “3rd Generation Partnership Project; Technical Specification Group Core Network and Terminals; Non-Access-Stratum (NAS) protocol for 5G System (5GS); Stage 3 (Release 17)”, September 2021
Non Patent Literature 4: 3GPP TS 23.256 V17.0.0 (2021-09) “3rd Generation Partnership Project; Technical Specification Group Services and System Aspects; Support of Uncrewed Aerial Systems (UAS) connectivity, identification and tracking; Stage 2 (Release 17)”, September 2021

### SUMMARY OF INVENTION

### Technical Problem

The inventors have studied and discovered various issues related to authentication and re-authorization procedures for a UAS Service. For example, it is not clear how a UE or core network node will handle a collision between a UUAA procedure and other mobility or session management procedures. Thus, one of objects of the example embodiments disclosed in the present disclosure is to provide an apparatus, a method, and a program that can appropriately handle a collision between a UUAA procedure and other mobility or session management procedures. It should be noted that this object is only one of a plurality of objects that the example embodiments disclosed herein seek to achieve. Other objects or issues and novel features are apparent from the description or accompanying drawings herein.

### Solution to Problem

In a first example aspect, an Access and Mobility Management Function (AMF) node includes: at least one memory; and at least one processor coupled to the at least one memory. The at least one processor is configured to: initiate a UAV Authentication and Authorization (UUAA-MM) procedure, receive a DEREGISTRATION REQUEST message in a UE-initiated de-registration procedure from an Uncrewed Aerial Vehicle (UAV), abort the UUAA-MM procedure in response to the receipt of the DEREGISTRATION REQUEST message, and proceed with the UE-initiated de-registration procedure in response to the receipt of the DEREGISTRATION REQUEST message.

In a second example aspect, a method in an Access and Mobility Management Function (AMF) node includes: initiating a UAV Authentication and Authorization (UUAA-MM) procedure; receiving a DEREGISTRATION REQUEST message in a UE-initiated de-registration procedure from an Uncrewed Aerial Vehicle (UAV); aborting the UUAA-MM procedure in response to the receipt of the DEREGISTRATION REQUEST message; and proceeding with the UE-initiated de-registration procedure when the AMF node receives the DEREGISTRATION REQUEST message.

In a third example aspect, a non-transitory computer readable medium stores a program for causing a computer to execute the above method according to the second example aspect.

In a fourth example aspect, an Uncrewed Aerial Vehicle (UAV) includes: at least one memory; and at least one processor coupled to the at least one memory. The at least one processor is configured to: initiate a UE-initiated de-registration procedure, receive a DL NAS TRANSPORT message in a UUAA-MM procedure from an Access and Mobility Management Function (AMF) node, ignore the received DL NAS TRANSPORT message, and proceed with the UE-initiated de-registration procedure upon receipt of the DL NAS TRANSPORT message.

In a fifth example aspect, a Session Management Function (SMF) node includes: at least one memory; and at least one processor coupled to the at least one memory. The at least one processor is configured to: initiate a UAV authentication and authorization procedure for session management (UUAA-SM procedure), receive a PDU SESSION RELEASE REQUEST message for a PDU session providing connectivity to a UAS NF 9 in a UE-requested PDU session release procedure, abort the UUAA-SM procedure in response to the receipt of the PDU SESSION RELEASE REQUEST message, and proceed with the UE-requested PDU session release procedure when the SMF node receives the PDU SESSION RELEASE REQUEST message.

In a sixth example aspect, a Session Management Function (SMF) node includes: at least one memory; and at least one processor coupled to the at least one memory. The at least one processor is configured to: initiate a C2 Communication Authorization Procedure (Authorization for C2 Procedure) or a UAV Authentication and Authorization Procedure (UUAA-SM Procedure), receive a PDU SESSION RELEASE REQUEST message in a UE-requested PDU session release procedure, abort the C2 communication authorization procedure or the UUAA-SM procedure in response to the receipt of the PDU SESSION RELEASE REQUEST message, and proceed with the UE-requested PDU session release procedure when the SMF node receives the PDU SESSION RELEASE REQUEST message.

In a seventh example aspect, an Uncrewed Aerial Vehicle (UAV) includes: at least one memory; and at least one processor coupled to the at least one memory. The at least one processor is configured to: initiate a UE-requested PDU session release procedure, receive an authentication message in a UUAA-SM procedure, ignore the received authentication message, and proceed with the UE-requested PDU session release procedure when the UAV receives the authentication message.

In an eighth example aspect, an Uncrewed Aerial Vehicle (UAV) includes: at least one memory; and at least one processor coupled to the at least one memory. The at least one processor is configured to: initiate a UE-requested PDU session release procedure, receive an authentication message in a C2 communication authorization procedure (Authorization for C2 procedure) or a UAV authentication and authorization procedure (UUAA-SM procedure), ignore the received authentication message, and proceed with the UE-requested PDU session release procedure when the UAV receives the authentication message.

In an ninth example aspect, an Uncrewed Aerial Vehicle (UAV) includes: at least one memory; and at least one processor coupled to the at least one memory. The at least one processor is configured to: receive from a network a PDU Session Modification Command message including information indicating that a C2 communication authorization procedure (Service-level authentication and authorization procedure) is in progress, and transmit to the network a PDU Session Modification Command Ack or PDU SESSION MODIFICATION COMPLETE message including information indicating that the UAV has recognized that the Service-level authentication and authorization procedure (C2 communication authorization procedure) is in progress.

### Advantageous Effects of Invention

According to the above example aspects, it is possible to provide an apparatus, a method, and a program that can appropriately handle a collision between a UUAA procedure and other mobility or session management procedures.

### BRIEF DESCRIPTION OF DRAWINGS

FIG. 1 shows a configuration example of a cellular network according to an example embodiment;

FIG. 2 is a flowchart showing an example of an operation of an AMF according to the example embodiment;

FIG. 3 is a sequence diagram showing an example of an operation of a UE, an AMF, and a UAS NF according to the example embodiment;

FIG. 4 is a flowchart showing an example of an operation of the UE according to the example embodiment;

FIG. 5 is a sequence diagram showing an example of an operation of the UE and the AMF according to the example embodiment;

FIG. 6 is a flowchart showing an example of an operation of an SMF according to the example embodiment;

FIG. 7 is a sequence diagram showing an example of an operation of the UE, the AMF, the SMF, and the UAS NF according to the example embodiment;

FIG. 8 is a flowchart showing an example of an operation of the SMF according to the example embodiment;

FIG. 9 is a sequence diagram showing an example of an operation of the UE, the AMF, the SMF, and the UAS NF according to the example embodiment;

FIG. 10 is a flowchart showing an example of an operation of the UE according to the example embodiment;

FIG. 11 is a sequence diagram showing an example of an operation of the UE and the AMF according to the example embodiment;

FIG. 12 is a flowchart showing an example of an operation of the UE according to the example embodiment;

FIG. 13 is a sequence diagram showing an example of an operation of the UE and the AMF according to the example embodiment;

FIG. 14 is a sequence diagram showing an example of an operation of the UE, the AMF, and the SMF according to the example embodiment;

FIG. 15 is a block diagram showing a configuration example of the UE according to the example embodiment; and

FIG. 16 is a block diagram showing a configuration example of the AMF, the SMF, and a UAS-NF according to the example embodiment.

### EXAMPLE EMBODIMENT

Hereinafter, specific example embodiments will be described in detail with reference to the drawings. In each drawing, the same or corresponding elements are given the same reference signs, and repeated descriptions will be omitted as necessary for clarity of description.

The example embodiments described below may be implemented independently or in combination as appropriate. These example embodiments have novel features that differ from each other. Thus, the plurality of example embodiments contribute to solving different objects or problems and to achieving different effects.

The following descriptions on the example embodiments mainly focus on the 3rd Generation Partnership Project (3GPP) fifth generation mobile communication system (5G system (5GS)). However, these example embodiments may be applied to other cellular communication systems that support network slicing similar to that of the 5GS.

In particular, Table 1 provides an example of vocabulary reinterpretation for applying the various example embodiments described below to the 3GPP 4th Generation Mobile Communication System (Evolved Packet System (EPS)).

TABLE 1

| Terminology used in the present | Terminology for application |
|---|---|
| disclosure | to EPS |
| AMF | MME |
| SMF | SGW |
| UDM | HSS |
| PDU session | PDN connection |
| PDU SESSION RELEASE REQUEST | PDN Disconnection Request |
| Nudm_UECM_{—} | Cancel Location |
| DeregistrationNotification | |
| PDU Session Modification procedure | Bearer modification procedure |

### First Example Embodiment

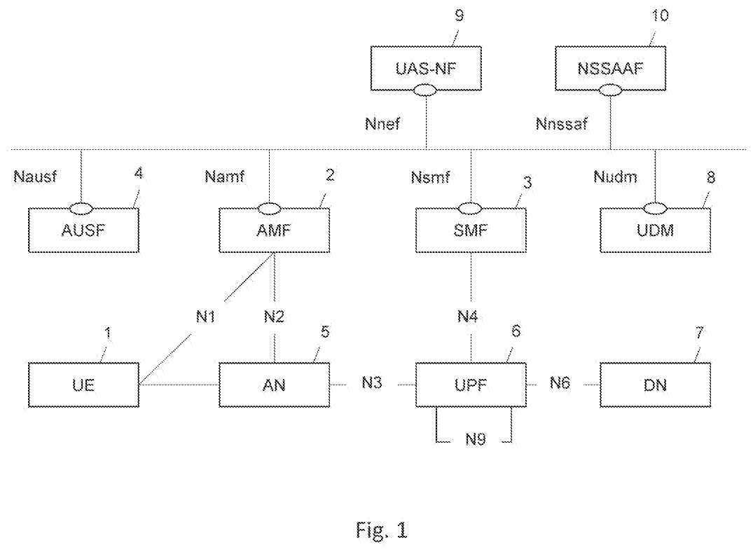

FIG. 1 shows a configuration example of a cellular network (i.e., 5GS) according to the present example embodiment. Each of the elements shown in FIG. 1 is a network function and provides an interface as defined by the 3rd Generation Partnership Project (3GPP). Each of the elements (network functions) shown in FIG. 1 can be implemented, for example, as a network element on dedicated hardware, as a software instance running on dedicated hardware, or as a virtual function instantiated on an application platform.

The cellular network shown in FIG. 1 may be provided by a Mobile Network Operator (MNO), or it may be a Non-Public Network (NPN) provided by a non-MNO. If the cellular network shown in FIG. 1 is an NPN, it may be an independent network, represented as a Stand-alone Non-Public Network (SNPN), or it may be an NPN linked to an MNO network, represented as a public network integrated NPN.

A radio terminal (i.e., UE or UAV) 1 uses 5G connectivity services and communicates with a data network (DN) 7. More specifically, the UE 1 is connected to an access network (i.e., 5G Access Network (5GAN)) 5 and communicates with the data network (DN) 7 via a User Plane Function (UPF) 6 in a core network (i.e., 5G core network (5GC)). Hereinafter, the UE can be interpreted as UAV and vice versa.

The AN 5 may include a Next Generation Radio Access Network (NG-RAN) or a non-3GPP AN, or both. The non-3GPP AN may be a network that handles wireless LAN (WiFi) communications or a network that handles wired communications, referred to as a Wireline 5G Access Network (W-5GAN). The UPF 6 may include multiple UPFs that are interconnected.

In the 5G architecture, the connectivity service between the UE 1 and the DN 7 is supported by one or more Protocol Data Unit (PDU) sessions. A PDU session is an association, session, or connection between the UE 1 and the DN 7. A PDU session is used to provide a PDU connectivity service (i.e., an exchange of PDUs between the UE 1 and the DN 7). The UE 1 establishes one or more PDU sessions between the UE 1 and the UPF 6 (i.e., the PDU session anchor) to which the DN 7 is connected. In terms of data transfer, a PDU session consists of a tunnel (N9 tunnel) in the 5GC, a tunnel (N3 tunnel) between the 5GC and the AN 5 and one or more radio bearers. The UE 1 may establish multiple PDU sessions with multiple UPFs (PDU session anchors) 6 in order to concurrently access multiple DNs 7.

The AMF 2 is one of the network functions in the 5GC Control Plane. The AMF 2 provides the termination of a RAN Control Plane (CP) interface (i.e., N2 interface). The AMF 2 terminates a single signalling connection (i.e., N1 NAS signalling connection) with the UE 1 and provides registration management, connection management, and mobility management. The AMF 2 provides NF services to NF consumers (e.g., other AMFs, Session Management Function (SMF) 3, and Authentication Server Function (AUSF) 4) on a service-based interface (i.e., Namf interface). The NF services provided by the AMF 2 include a communication service (e.g., Namf_Communication). The communication service allows NF consumers (e.g., SMF 3) to communicate with the UE 1 or AN 5 via the AMF 2.

The SMF 3 is one of the network functions in the 5GC Control Plane. The SMF 3 manages PDU sessions. The SMF 3 sends and receives SM signalling messages (e.g., NAS-SM messages, N1 SM messages) to and from the Non-Access-Stratum (NAS) Session Management (SM) layer of the UE 1 via communication services provided by the AMF 2. The SMF 3 provides NF services on a service-based interface (i.e., Nsmf interface) to NF consumers (e.g., AMF 2, other SMFs). The NF services provided by the SMF 3 include a PDU session management service (e.g., Nsmf_PDUSession), which allows the NF consumer (e.g., AMF 2) to handle PDU sessions. The SMF 3 may be an Intermediate SMF (I-SMF). The I-SMF is inserted between the AMF 2 and an original SMF 3 as needed when the UPF 6 belongs to a different SMF service area and cannot be controlled by the original SMF.

The AUSF 4 is one of the network functions in the 5GC Control Plane. The AUSF 4 provides NF services on a service based interface (i.e., Nausf interface) to NF consumers (e.g., AMF 2, UDM 8). The NF services provided by the AUSF 4 include a UE authentication service (e.g., Nausf_UEAuthentication and Nausf_NSSAA_Authenticate). The Nausf_UEAuthentication service provides UE authentication and related key information (keying material) to the NF consumer (i.e., AMF). More specifically, the AUSF 4 cooperates with the UDM 8 and Authentication credential Repository and Processing Function (ARPF) to perform authentication using one of the two authentication methods (i.e., 5G-Authentication and Key Agreement (AKA) and EAP-based authentication) supported by the 5GS. After performing the authentication, the AUSF 4 replies to the AMF 2 with the authentication result and, if successful, a master key. The master key is used by the AMF 2 to derive NAS security keys and other security key(s). For UE authentication, the AUSF 4 works closely with the UDM 8. The Nausf_NSSAA_Authenticate service provides the NF consumer (e.g., AMF 2) with a Network Slice-Specific Authentication and Authorization service between the UE 1 and an AAA server via the AUSF 4.

The UDM 8 is one of the network functions in the 5GC Control Plane. The UDM 8 provides access to a database (i.e., User Data Repository (UDR)) storing subscriber data (subscription information). The UDM 8 provides NF services on a service-based interface (i.e., Nudm interface) to NF consumers (e.g., AMF 2, AUSF 4, SMF 3). The NF services provided by the UDM 8 include a subscriber data management service, which allows the NF consumer (e.g., AMF) to retrieve subscriber data and provides updated subscriber data to the NF consumer.

A UAS NF 9 is one of the network functions in the 5GC Control Plane. The UAS NF 9 is supported by the NEF (Network Exposure Function) or SCEF (Service Capability Exposure Function)+NEF and is used for external exposure of services to the USS. The SCEF+NEF node is associated with the UE for Service Capability Exposure if the UE supports mobility between EPS and 5GS. The UAS NF 9 uses the existing NEF/SCEF external exposure in controlling UAV authentication/authorization, UAV flight authorization, UAV-UAVC pairing authorization, and their revocation, location reporting, and QoS/traffic filtering for the C2 communications. The UAS NF 9 may be implemented and deployed in the form of a dedicated NEF that implements only the UAS NF function. The UAS NF may be described as a UAS-NF.

The UAS NF 9 stores and maintains information about whether re-authentication is in the AMF or SMF/SMF+PGW-C and the address of the serving AMF or SMF/SMF+PGW-C to support a re-authentication request by the USS. The SMF/PGW-C is a core network node used for PDN connectivity when 5GS and EPS interworking is supported. In addition, the UAS NF 9 stores and maintains the result of the UUAA-MM procedure and the result of the UUAA-SM procedure.

An NSSAAF (Network Slice-specific and SNPN Authentication and Authorization Function) 10 connects to an AAA server (AAA-S), which is an authentication server, and supports network slice-specific authentication and authorization functions. If the AAA-S belongs to a third party, the NSSAAF connects to the AAA-S via the AAA proxy (AAA-P).

A configuration example of FIG. 1 shows only representative NFs for explanatory purposes. The cellular network according to this example embodiment may include other NFs not shown in FIG. 1, such as Network Slice Selection Function (NSSF), Policy Control Function (PCF), Application Function (AF), NEF, and Network Repository Function (NRF).

The inventors have studied and discovered various issues related to authentication and re-authorization procedures for the UAS Service. For example, if the UE 1 executes a de-registration procedure while the network is executing the UUAA-MM procedure, it is not clear how the AMF 2 will handle a DEREGISTRATION REQUEST message from the UE 1. In this case, there may be a collision between the UUAA-MM procedure and a UE-initiated de-registration procedure in the network, causing either or both procedures to fail.

This example embodiment provides a solution for appropriately handling a collision between the UUAA-MM procedure and the UE-initiated de-registration procedure in the network.

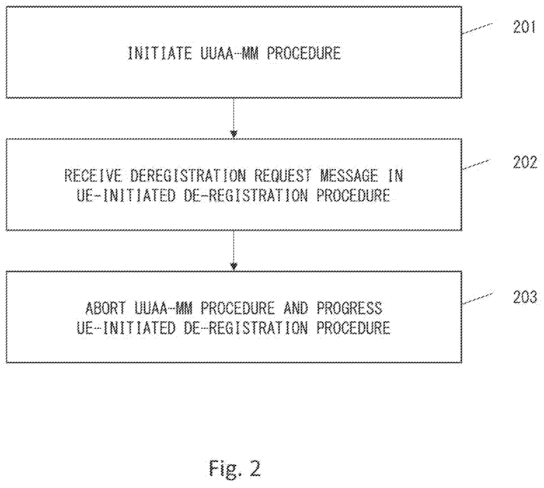

FIG. 2 is a flowchart showing an example of an operation of the AMF 2 according to this example embodiment.

In step 201, the AMF 2 initiates the UAV authentication and authorization procedure (UUAA-MM procedure) in mobility management. The AMF 2 may initiate the UAV authentication and authorization procedure by transmitting an Nnef_Authentication_authenticate request message including a GPSI (Generic Public Subscription Identifier) and a CAA-Level UAV ID to the UAS NF 9. In the UUAA-MM procedure, the AMF 2 invokes an Nnef_Authentication_authenticate service operation. The Nnef_Authentication_authenticate service operation can include a USS address (e.g., Fully Qualified Domain Name (FQDN)) and a UUAA Aviation Payload. The UAS NF 9 identifies the USS address based on the USS address designated by the CAA-Level UAV ID or the UE 1. The AMF 2 can include user location information (e.g., cell ID) in the Nnef_Authentication_authenticate service operation.

In step 202, the AMF 2 receives the DEREGISTRATION REQUEST message in the UE-initiated de-registration procedure initiated by the UE 1. The DEREGISTRATION REQUEST message may be set with access type information (“3GPP” and/or “non 3GPP”) that designates the access to be subject to de-registration.

In step 203, the AMF 2 aborts the UUAA-MM procedure and progress the UE-initiated de-registration procedure. The AMF 2 aborting the UUAA-MM procedure may mean that the AMF 2 and the associated network node (e.g., UAS NF 9) progress processing to abort the UUAA-MM procedure prior to progressing the UE-initiated de-registration procedure. As another example, the AMF 2 may verify that the access type information included in the DEREGISTRATION REQUEST message matches the access type executing the UUAA-MM procedure. If, as a result of the verification, the access type information included in the DEREGISTRATION REQUEST message matches the access type executing the UUAA-MM procedure, the AMF 2 may abort the UUAA-MM procedure and progress the UE-initiated de-registration procedure. Specifically, if the access type information included in the DEREGISTRATION REQUEST message is set to “3GPP access and non-3GPP access” and the access type executing the UUAA-MM procedure is “3GPP access” and/or “non-3GPP access”, the AMF 2 may abort the UUAA-MM procedure and progress the UE-initiated de-registration. If, as a result of the verification, the access type information included in the DEREGISTRATION REQUEST message does not match the access type executing the UUAA-MM procedure, the AMF 2 may progress both the UUAA-MM procedure and the UE-initiated de-registration procedure. Specifically, if the access type information included in the DEREGISTRATION REQUEST message is set to “3GPP access” and the access type executing the UUAA-MM procedure is “non 3GPP access”, the AMF 2 may progress both the UUAA-MM procedure and the UE-initiated de-registration procedure. If the access type information included in the DEREGISTRATION REQUEST message is set to “non 3GPP access” and the access type executing the UUAA-MM procedure is “3GPP access”, the AMF 2 may progress both the UUAA-MM procedure and the UE-initiated de-registration procedure.

According to the operation shown in FIG. 2, when there is a collision between the UUAA-MM procedure and the UE-initiated de-registration procedure in the network, the AMF 2 aborts the UUAA-MM procedure and progresses the UE-initiated de-registration procedure. When there is a collision between the UUAA-MM procedure and the UE-initiated de-registration procedure in the network, the AMF 2 may prioritize to progress the UE-initiated de-registration procedure by aborting the UUAA-MM procedure. Thus, even when there is a collision between the UUAA-MM procedure and the UE-initiated de-registration procedure in the network, the network can handle both procedures appropriately.

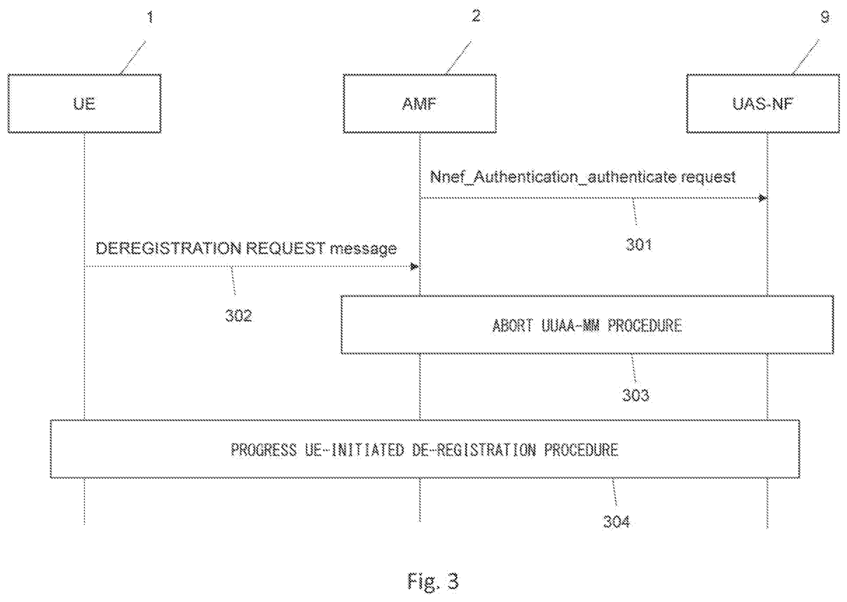

FIG. 3 shows an example of the UE-initiated de-registration procedure during the UUAA-MM procedure.

In step 301, the AMF 2 initiates the UAV authentication and authorization procedure (UUAA-MM procedure) in mobility management. The AMF 2 may initiate the UAV authentication and authorization procedure by transmitting the Nnef_Authentication_authenticate request message including the GPSI and the CAA-Level UAV ID to the UAS NF 9. In the UUAA-MM procedure, the AMF 2 invokes the Nnef_Authentication_authenticate service operation. The Nnef_Authentication_authenticate service operation can include the USS address (e.g., FQDN) and the UUAA Aviation Payload. The UAS NF 9 identifies the USS address based on the USS address designated by the CAA-Level UAV ID or the UE 1. The AMF 2 can include user location information (e.g., cell ID) in the Nnef_Authentication_authenticate service operation.

In step 302, the AMF 2 receives from the UE 1 the DEREGISTRATION REQUEST message in the UE-initiated de-registration procedure initiated by the UE 1. The DEREGISTRATION REQUEST message may be set with the access type information (“3GPP” and/or “non 3GPP”) that designates the access to be subject to de-registration.

In step 303, the AMF 2 aborts the UUAA-MM procedure in response to the DEREGISTRATION REQUEST message received from the UE 1. As an example, the AMF 2 may detect a Registration status change event for the UE 1 based on the initiation of the UE-initiated de-registration procedure and notify the UAS NF 9 that the registration status of the UE 1 has changed to “DEREGISTERED”. The event notification may be referred to as Namf_EventExposure_Notify. A Namf_EventExposure_Notify service operation may be initiated by the event notification. The UAS NF 9 aborts the UUAA-MM procedure based on the event notification. The UAS NF 9 subscribes to an AMF service before receiving the event notification in order to receive the event notification from the AMF 2. The subscription to the AMF service may be referred to as Namf_EventExposure_Subscribe or Namf_EventExposure_Subscribe service operation. In response to the receipt of the Nnef_Authentication_authenticate request message in step 301, the UAS NF 9 may initiate the Namf_EventExposure_Subscribe service operation to subscribe to the AMF service. After the UUAA-MM procedure succeeds, the UAS NF 9 may initiate the Namf_EventExposure_Subscribe service operation to subscribe to the AMF service. If the UUAA-MM procedure succeeds, the UAS NF 9 stores the UUAA context of the UAV indicating successful authentication and authorization and transmits an Nnef_Authentication_authenticate response to the AMF 2 with information indicating successful authentication and authorization. If the Namf_EventExposure_Subscribe service operation is initiated after the UUAA-MM procedure succeeds, the UAS NF 9 may delete the stored UUAA context of the UAV indicating successful authentication and authorization in addition to the above operation to abort the UUAA-MM procedure. As another example, in response to the receipt of the DEREGISTRATION REQUEST message from the UE 1, the AMF 2 may transmit a request message including information indicating EAP failure to the UAS NF 9 and invoke the Nnef_Authentication_authenticate service operation. The UAS NF 9 aborts the UUAA-MM procedure in response to the invocation of the service operation. At this time, the UAS NF 9 may delete the UUAA context of the UAV if it has already stored the UUAA context of the UAV indicating successful authentication and authorization. As another example, the AMF 2 may verify that the access type information included in the DEREGISTRATION REQUEST message matches the access type executing the UUAA-MM procedure. If, as a result of the verification, the access type information included in the DEREGISTRATION REQUEST message matches the access type executing the UUAA-MM procedure, the AMF 2 may abort the UUAA-MM procedure and progress the UE-initiated de-registration procedure. If, as a result of the verification, the access type information included in the DEREGISTRATION REQUEST message does not match the access type executing the UUAA-MM procedure, the AMF 2 may progress both the UUAA-MM procedure and the UE-initiated de-registration procedure.

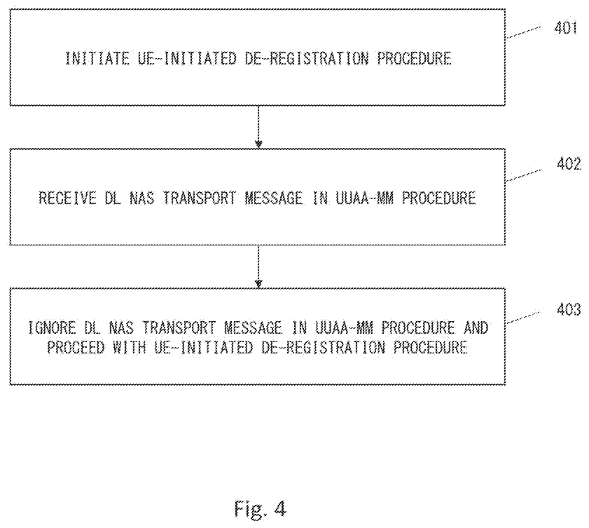

In step 304, the AMF 2 aborts the UUAA-MM procedure in step 303 and then progresses the UE-initiated de-registration procedure. In response to the DEREGISTRATION REQUEST message received from the UE 1 in step 302, the AMF 2 may simultaneously abort the UUAA-MM procedure in step 303 and progress the UE-initiated de-registration procedure. The UE-initiated de-registration procedure is similar to the existing UE-initiated de-registration procedure. The existing UE-initiated de-registration procedure is defined in FIG. 4.2.2.3.2-1 of Non Patent Literature 2.

According to the operation shown in FIG. 3, when there is a collision between the UUAA-MM procedure and the UE-initiated de-registration procedure in the network, the AMF 2 aborts the UUAA-MM procedure and progresses the UE-initiated de-registration procedure. When there is a collision between the UUAA-MM procedure and the UE-initiated de-registration procedure in the network, the AMF 2 may prioritize to progress the UE-initiated de-registration procedure by aborting the UUAA-MM procedure. Thus, even when there is a collision between the UUAA-MM procedure and the UE-initiated de-registration procedure in the network, the network can handle both procedures appropriately.

As a modified example of the first example embodiment, instead of step 302, the AMF 2 may receive a Nudm_UECM_Deregistration Notification from the UDM 8. In this case, the AMF 2 aborts the UUAA-MM procedure and progresses a Network-initiated de-registration procedure initiated by the UDM 8. The specific operation executed by the AMF 9 on the UAS NF 9 may be the same as the operation performed when the AMF 2 receives the DEREGISTRATION REQUEST message from the UE 1 (i.e., the operation described in step 303). In this case, the AMF 2 progresses the Network-initiated de-registration procedure initiated by the UDM 8 instead of step 304. The Network-initiated de-registration procedure may be progressed as defined in the drawing in 4.2.2.3.3-1 of Non Patent Literature 2.

According to the modified example of the first example embodiment, when there is a collision between the UUAA-MM procedure and the Network-initiated de-registration procedure initiated by the UDM 8 in the network, the AMF 2 aborts the UUAA-MM procedure and progresses the Network-initiated de-registration procedure initiated by the UDM 8. When there is a collision between the UUAA-MM procedure and the Network-initiated de-registration procedure initiated by the UDM 8 in the network, the AMF 2 may prioritize to progress the Network-initiated de-registration procedure initiated by the UDM 8 by aborting the UUAA-MM procedure. Thus, even when there is a collision between the UUAA-MM procedure and the Network-initiated de-registration procedure initiated by the UDM 8 in the network, the network can handle both procedures appropriately.

### Second Example Embodiment

The inventors have studied and discovered various issues related to authentication and re-authorization procedures for a UAS Service. For example, if a network executes a UUAA-MM procedure while a UE is executing a UE-initiated de-registration procedure, it is not clear how the UE will handle a DL NAS TRANSPORT message in the UUAA-MM procedure from the network. In this case, there may be a collision between the UE-initiated de-registration procedure and UUAA-MM procedure at the UE, causing either or both procedures to fail.

This example embodiment provides a solution for appropriately handling a collision between the UUAA-MM procedure and the UE-initiated de-registration procedure at the UE.

A configuration example of a cellular network according to this example embodiment may be similar to that of the example shown in FIG. 1.

FIG. 4 is a flowchart showing an example of an operation of the UE 1 according to this example embodiment.

In step 401, the UE 1 initiates the UE-initiated de-registration procedure. The UE 1 transmits to the AMF 2 the DEREGISTRATION REQUEST message in the UE-initiated de-registration procedure. The DEREGISTRATION REQUEST message may be set with access type information (“3GPP” and/or “non 3GPP”) that designates the access to be subject to de-registration.

In step 402, the UE 1 receives the DL NAS TRANSPORT message in the UUAA-MM procedure from the AMF 2. The DL NAS TRANSPORT message may include a service-level authentication and authorization (Service-level-AA) container information element (IE) with an authentication message set.

In step 403, the UE 1 ignores the DL NAS TRANSPORT message in the UUAA-MM procedure and proceeds with the UE-initiated de-registration procedure. The UE 1 ignoring the DL NAS TRANSPORT message may mean that the UE 1 does not perform further UUAA-MM procedures in response to the receipt of the DL NAS TRANSPORT message. The UE 1 ignoring the DL NAS TRANSPORT message may mean that the UE 1 suspends the proceeding of or temporarily does not perform the UUAA-MM procedures in response to the receipt of the DL NAS TRANSPORT message. As another example, the UE 1 may verify that the access type information included in the DEREGISTRATION REQUEST message matches the access type executing the UUAA-MM procedure. If, as a result of the verification, the access type information included in the DEREGISTRATION REQUEST message matches the access type executing the UUAA-MM procedure, the UE 1 may ignore the DL NAS TRANSPORT message in the UUAA-MM procedure and proceed with the UE-initiated de-registration procedure. Specifically, if the access type information included in the DEREGISTRATION REQUEST message is set to “3GPP access and non-3GPP access” and the access type executing the UUAA-MM procedure is “3GPP access” and/or “non-3GPP access”, the UE 1 may ignore the DL NAS TRANSPORT message in the UUAA-MM procedure and proceed with the UE-initiated de-registration procedure. If, as a result of the verification, the access type information included in the DEREGISTRATION REQUEST message does not match the access type executing the UUAA-MM procedure, the UE 1 may proceed with both the UUAA-MM procedure and the UE-initiated de-registration procedure. Specifically, if the access type information included in the DEREGISTRATION REQUEST message is set to “3GPP access” and the access type executing the UUAA-MM procedure is “non 3GPP access”, the UE 1 may proceed with both the UUAA-MM procedure and the UE-initiated de-registration procedure. If the access type information included in the DEREGISTRATION REQUEST message is set to “non 3GPP access” and the access type executing the UUAA-MM procedure is “3GPP access”, the AMF 2 may proceed with both the UUAA-MM procedure and the UE-initiated de-registration procedure.

According to the operation shown in FIG. 4, when there is a collision between the UUAA-MM procedure and the UE-initiated de-registration procedure in the UE 1, the UE 1 ignores the UUAA-MM procedure and proceeds with the UE-initiated de-registration procedure. When there is a collision between the UUAA-MM procedure and the UE-initiated de-registration procedure in the network, the UE 1 may prioritize to proceed with the UE-initiated de-registration procedure by ignoring the UUAA-MM procedure. Thus, even when there is a collision between the UUAA-MM procedure and the UE-initiated de-registration procedure in the UE 1, the UE 1 can handle both procedures appropriately.

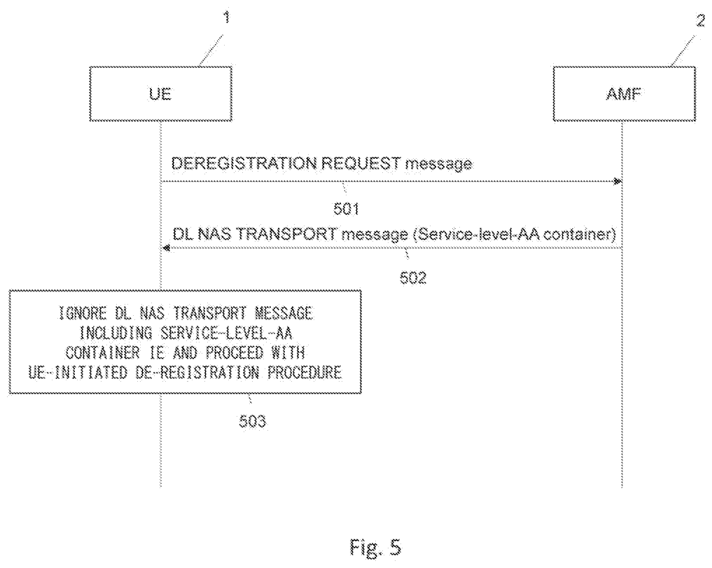

FIG. 5 shows an example of the UE-initiated de-registration procedure during the UUAA-MM procedure.

In step 501, the UE 1 initiates the UE-initiated de-registration procedure. The UE 1 may initiate the UE-initiated de-registration procedure by transmitting the DEREGISTRATION REQUEST message to the AMF 2. The DEREGISTRATION REQUEST message may be set with access type information (“3GPP” and/or “non 3GPP”) that designates the access to be subject to de-registration.

In step 502, the UE 1 receives the DL NAS TRANSPORT message in the UUAA-MM procedure from the AMF 2. Specifically, the UE 1 receives the DL NAS TRANSPORT message including the Service-level-AA container IE with an authentication message set.

In step 503, the UE 1 ignores the DL NAS TRANSPORT message in the UUAA-MM procedure received from the AMF 2 and proceeds with the UE-initiated de-registration procedure. As another example, the UE 1 may verify that the access type information included in the DEREGISTRATION REQUEST message matches the access type executing the UUAA-MM procedure. If, as a result of the verification, the access type information included in the DEREGISTRATION REQUEST message matches the access type executing the UUAA-MM procedure, the UE 1 may ignore the DL NAS TRANSPORT message in the UUAA-MM procedure and proceed with the UE-initiated de-registration procedure. If, as a result of the verification, the access type information included in the DEREGISTRATION REQUEST message does not match the access type executing the UUAA-MM procedure, the UE 1 may proceed with both the UUAA-MM procedure and the UE-initiated de-registration procedure.

According to the operation shown in FIG. 5, when there is a collision between the UUAA-MM procedure and the UE-initiated de-registration procedure in the UE 1, the UE 1 ignores the UUAA-MM procedure and proceeds with the UE-initiated de-registration procedure. When there is a collision between the UUAA-MM procedure and the UE-initiated de-registration procedure in the network, the UE 1 may prioritize to proceed with the UE-initiated de-registration procedure by ignoring the UUAA-MM procedure. Thus, even when there is a collision between the UUAA-MM procedure and the UE-initiated de-registration procedure in the UE 1, the UE 1 can handle both procedures appropriately.

### Third Example Embodiment

The inventors have studied and discovered various issues related to authentication and re-authorization procedures for a UAS Service. For example, if a UE executes a PDU session release procedure while a network is executing a UUAA-SM procedure, it is not clear how an SMF will handle a PDU SESSION RELEASE REQUEST message from the UE. In this case, there may be a collision between the UUAA-SM procedure and a UE-requested PDU session release procedure on the network, causing either or both procedures to fail.

This example embodiment provides a solution for appropriately handling a collision between the UE-requested PDU session release procedure and the UAV authentication and authorization procedure (UUAA-SM procedure) on the network. This example embodiment also provides a solution for appropriately handling a collision between the UE-requested PDU session release procedure and the UAV re-authentication and re-authorization procedure (UUAA-SM procedure) on the network. Therefore, in the third example embodiment, the procedure for UAV authentication and authorization (UUAA-SM procedure) can be interpreted as the procedure for UAV re-authentication and re-authorization (UUAA-SM procedure) and vice versa.

A configuration example of a cellular network according to this example embodiment may be similar to that of the example shown in FIG. 1.

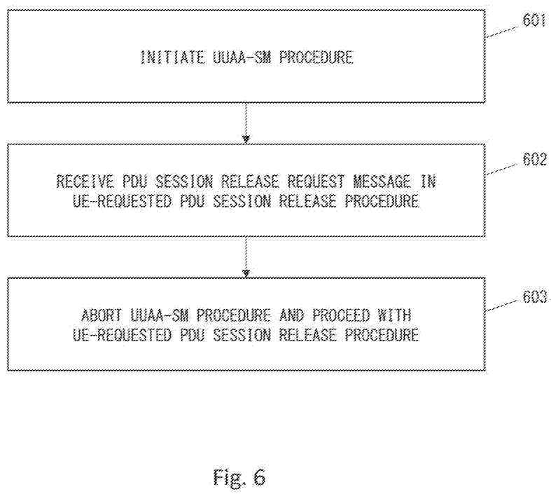

FIG. 6 is a flowchart showing an example of an operation of the SMF 3 according to this example embodiment.

In step 601, the SMF 3 initiates the UAV authentication and authorization procedure (UUAA-SM procedure) for session management. The UUAA-SM procedure may be initiated in response to receipt of an authentication and authorization request (Nnef_Auth_Notification notify) message from the UAS_NF 9. In the UUAA-SM procedure, the SMF 3 invokes an Nnef_Authentication_Authenticate service operation.

In step 602, the SMF 3 receives from the UE 1 via the AMF 2 the PDU SESSION RELEASE REQUEST message for a PDU session providing the connectivity to the UAS NF 9. The PDU SESSION RELEASE REQUEST message is a message in the UE-requested PDU session release procedure.

In step 603, the SMF 3 aborts the UUAA-SM procedure and proceeds with the UE-requested PDU session release procedure. The SMF 3 aborting the UUAA-SM procedure may mean that the SMF 3 and the associated network node (e.g., UAS NF 9) proceed with processing to abort the UUAA-SM procedure prior to proceeding with the UE-initiated de-registration procedure. As another example, if the PDU session designated in the PDU SESSION RELEASE REQUEST message is a PDU session designated in the UUAA-SM procedure, the SMF 3 may abort the UUAA-SM procedure and proceed with the UE-requested PDU session release procedure.

According to the operation shown in FIG. 6, when there is a collision between the UE-requested PDU session release procedure and the UUAA-SM procedure, the SMF 3 aborts the UUAA-SM procedure and proceeds with the UE-requested PDU session release procedure. When there is a collision between the UE-requested PDU session release procedure and the UUAA-SM procedure, the SMF 3 may prioritize to proceed with the UE-requested PDU session release procedure by aborting the UUAA-SM procedure. Thus, even if there is a collision between the UE-requested PDU session release procedure and the UUAA-SM procedure in the SMF 3, the SMF 3 can handle both procedures appropriately.

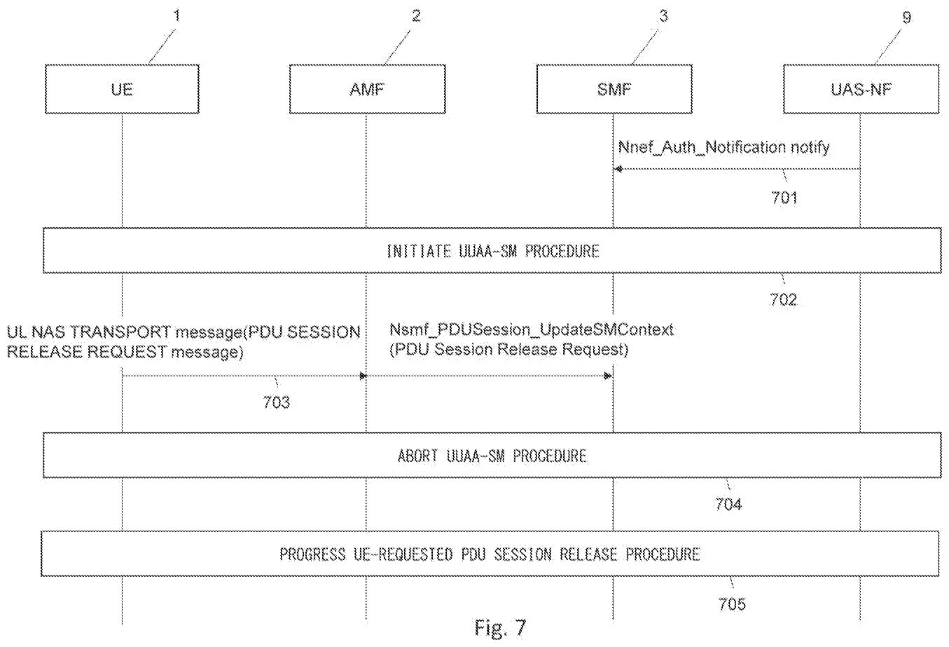

FIG. 7 shows an example of the UE-requested PDU session release procedure during the UUAA-SM procedure.

In step 701, the SMF 3 initiates the UAV authentication and authorization procedure for session management (UUAA-SM procedure). The SMF 3 may initiate the UAV authentication and authorization procedure by receiving an Nnef_Auth_Notification notify message from the UAS NF 9. The SMF 3 invokes the Nnef_Auth_Notification service operation.

In step 702, the SMF 3 initiates the UUAA-SM procedure based on the receipt of the Nnef_Auth_Notification notify message from the UAS NF 9. Specifically, an authentication message based on the authentication method to be used is transmitted to the UE 1 via the AMF 2. The existing UUAA-SM procedure is defined in FIG. 5.2.4.1-1 of Non Patent Literature 4.

In step 703, the SMF 3 receives from the UE 1 via the AMF 2 a PDU SESSION RELEASE REQUEST message for a PDU session providing the connectivity to the UAS NF 9. The PDU SESSION RELEASE REQUEST message is a message in the UE-requested PDU session release procedure.

In step 704, the UUAA-SM procedure is aborted in response to the PDU SESSION RELEASE REQUEST message received from the UE 1. As another example, the SMF 3 may abort the UUAA-SM procedure and proceed with the UE-requested PDU session release procedure if the PDU session designated in the PDU SESSION RELEASE REQUEST message is a PDU session specified in the UUAA-SM procedure.

In step 705, the SMF 3 aborts the UUAA-SM procedure in step 704 and then progresses the UE-requested PDU session release procedure. In response to the PDU SESSION RELEASE REQUEST message received from the UE 1 in step 703, the SMF 3 may simultaneously abort the UUAA-SM procedure in step 704 and progress the UE-requested PDU session release procedure.

According to the operation shown in FIG. 7, when there is a collision between the UE-requested PDU session release procedure and the UUAA-SM procedure, the SMF 3 aborts the UUAA-SM procedure and proceeds with the UE-requested PDU session release procedure. When there is a collision between the UE-requested PDU session release procedure and the UUAA-SM procedure, the SMF 3 may prioritize to proceed with the UE-requested PDU session release procedure by aborting the UUAA-SM procedure. Thus, even if there is a collision between the UE-requested PDU session release procedure and the UUAA-SM procedure in the SMF 3, the SMF 3 can handle both procedures appropriately.

### Fourth Example Embodiment

The inventors have studied and discovered various issues related to authentication and re-authorization procedures for a UAS Service. For example, if a UE executes a PDU session release procedure while a network is executing a C2 communication authorization procedure, it is not clear how an SMF will handle a PDU SESSION RELEASE REQUEST message from the UE. In this case, there may be a collision between the C2 communication authorization procedure and a UE-requested PDU session release procedure on the network, causing either or both procedures to fail.

This example embodiment provides a solution for appropriately handling a collision between the UE-requested PDU session release procedure and the C2 communication authorization procedure on the network. The C2 communication authorization procedure is a procedure for pairing a UAV with a UAV-C to achieve C2 communication.

A configuration example of a cellular network according to this example embodiment may be similar to that of the example shown in FIG. 1.

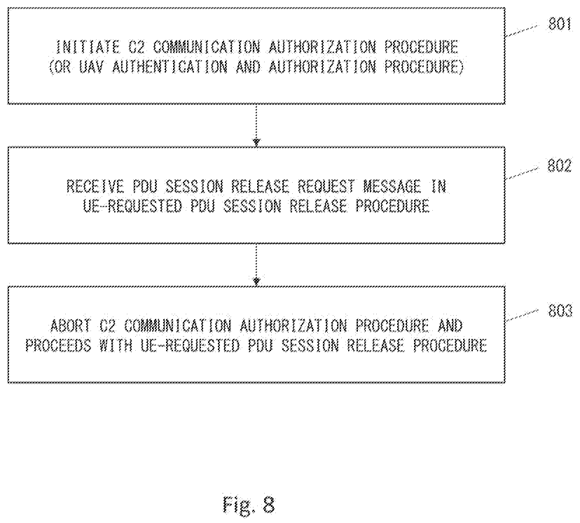

FIG. 8 is a flowchart showing an example of an operation of the SMF 3 according to this example embodiment.

In step 801, the SMF 3 initiates an Authorization for C2 procedure for pairing the UAV with the UAV-C to achieve the C2 communication. The SMF 3 may initiate the C2 communication authorization procedure by receiving a PDU SESSION MODIFICATION REQUEST message from the UE 1 via the AMF 2. In the C2 communication authorization procedure, the SMF 3 invokes an Nnef_Auth_Reauth service operation. The C2 communication authorization procedure may be referred to as Authorization of C2 communication.

In step 802, the SMF 3 receives the PDU SESSION RELEASE REQUEST message in the UE-requested PDU session release procedure from the UE 1 via the AMF 2.

In step 803, the SMF 3 aborts the C2 communication authorization procedure and proceeds with the UE-requested PDU session release procedure. The SMF 3 aborting the C2 communication authorization procedure may mean that the SMF 3 and the associated network node (e.g., UAS NF 9) proceed with processing to abort the C2 communication authorization prior to proceeding with the UE-requested PDU session release procedure. As another example, if the PDU session designated in the PDU SESSION RELEASE REQUEST message is a PDU session designated in the C2 communication authorization procedure, the SMF 3 may abort the C2 communication authorization procedure and proceed with the UE-requested PDU session release procedure.

In this example embodiment, the C2 communication authorization procedure may be interpreted as the UAV Authentication and Authorization (UUAA) procedure and vice versa.

According to the operation shown in FIG. 8, when there is a collision between the UE-requested PDU session release procedure and the C2 communication authorization procedure (or UAV authentication and authorization procedure), the SMF 3 aborts the C2 communication authorization procedure (or UAV authentication and authorization procedure) and proceeds with the UE-requested PDU session release procedure. When there is a collision between the UE-requested PDU session release procedure and the C2 communication authorization procedure (or UAV authentication and authorization procedure), the SMF 3 may prioritize to proceed with the UE-requested PDU session release procedure by aborting the C2 communication authorization procedure (or UAV authentication and authorization procedure). Thus, even if there is a collision between the UE-requested PDU session release procedure and the C2 communication authorization procedure (or UAV authentication and authorization procedure) in the SMF 3, the SMF 3 can handle both procedures appropriately.

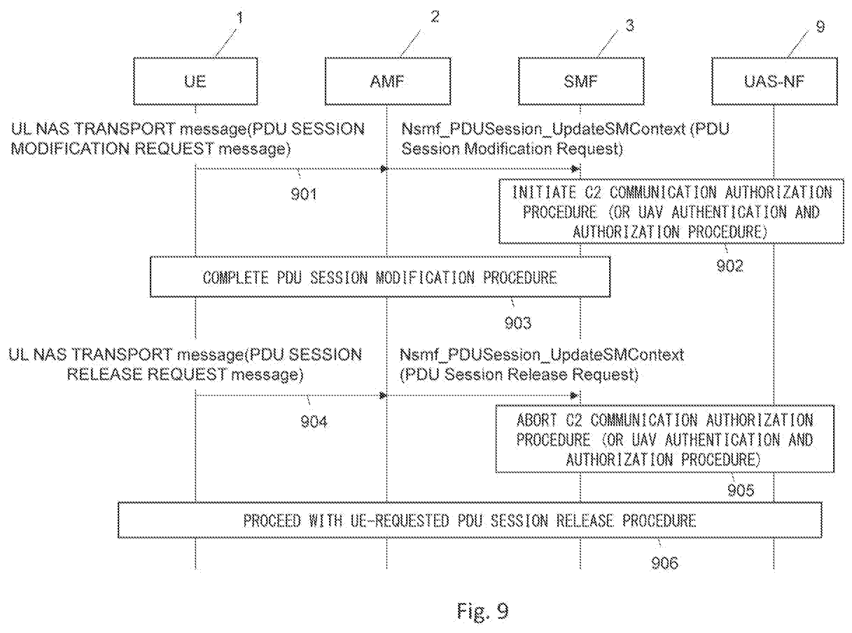

FIG. 9 shows an example of the UE-requested PDU session release procedure during the C2 communication authorization procedure.

In step 901, the SMF 3 receives the PDU SESSION MODIFICATION REQUEST message in the PDU session modification procedure from the UE 1 via the AMF 2.

In step 902, the SMF 3 initiates the C2 communication authorization procedure in response to the receipt of the PDU SESSION MODIFICATION REQUEST message from the UE 1. Specifically, the SMF 3 invokes the Nnef_Auth_Reauth service operation. The existing C2 communication authorization procedure is specified in FIG. 5.2.5.2.2-1 of Non Patent Literature 4.

In step 903, the SMF 3 completes the PDU session modification procedure. The PDU session modification procedure may be similar to the existing PDU session modification procedure. The existing PDU session modification procedure is defined in FIG. 4.3.3.2-1 of Non Patent Literature 2.

In step 904, the SMF 3 receives the PDU SESSION RELEASE REQUEST message in the UE-requested PDU session release procedure from the UE 1 via the AMF 2.

In step 905, the SMF 3 aborts the C2 communication authorization procedure in response to the PDU SESSION RELEASE REQUEST message received from the UE 1. As another example, if the PDU session designated in the PDU SESSION RELEASE REQUEST message is a PDU session designated in the C2 communication authorization procedure, the SMF 3 may abort the C2 communication authorization procedure and proceed with the UE-requested PDU session release procedure.

In step 906, the SMF 3 aborts the C2 communication authorization procedure in step 905 and then progresses the UE-requested PDU session release procedure. In response to the PDU SESSION RELEASE REQUEST message received from the UE 1 in step 904, the SMF 3 may simultaneously abort the C2 communication authorization procedure in step 905 and progress the UE-requested PDU session release procedure.

In this example embodiment, the C2 communication authorization procedure may be interpreted as the UAV Authentication and Authorization (UUAA) procedure and vice versa.

According to the operation shown in FIG. 9, when there is a collision between the UE-requested PDU session release procedure and the C2 communication authorization procedure (or UAV authentication and authorization procedure) the SMF 3 aborts the C2 communication authorization procedure (or UAV authentication and authorization procedure) and proceeds with the UE-requested PDU session release procedure. When there is a collision between the UE-requested PDU session release procedure and the C2 communication authorization procedure (or UAV authentication and authorization procedure), the SMF 3 may prioritize to proceed with the UE-requested PDU session release procedure by aborting the C2 communication authorization procedure (or UAV authentication and authorization procedure). Thus, even if there is a collision between the UE-requested PDU session release procedure and the C2 communication authorization procedure (or UAV authentication and authorization procedure) in the SMF 3, the SMF 3 can handle both procedures appropriately.

### Fifth Example Embodiment

The inventors have studied and discovered various issues related to authentication and re-authorization procedures for the UAS Service. For example, if a network executes a UUAA-SM procedure while a UE is executing a PDU session release procedure, it is not clear how the UE will handle an authentication/authorization message in the UUAA-SM procedure from the network. In this case, there may be a collision between the PDU session release procedure and UUAA-SM procedure at the UE, causing either or both procedures to fail.

This example embodiment provides a solution for appropriately handling a collision between the UE-requested PDU session release procedure and the UUAA-SM procedure at the UE.

A configuration example of a cellular network according to this example embodiment may be similar to that of the example shown in FIG. 1.

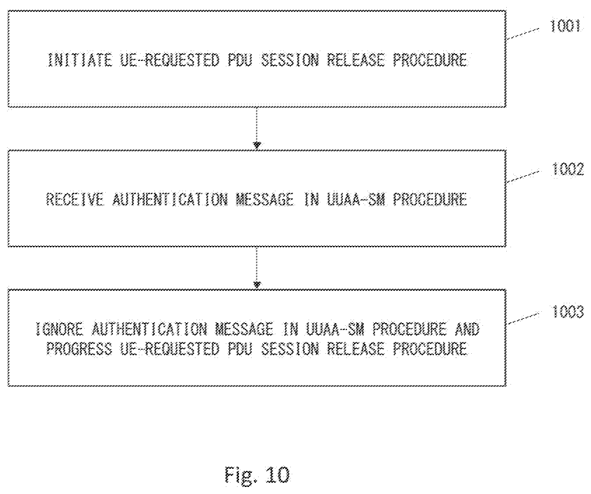

FIG. 10 is a flowchart showing an example of an operation of the UE 1 according to this example embodiment.

In step 1001, the UE 1 initiates the UE-requested PDU session release procedure. The UE 1 may initiate the UE-requested PDU session release procedure by transmitting a UL NAS TRANSPORT message including a PDU SESSION RELEASE REQUEST message to the SMF 3.

In step 1002, the UE 1 receives a DL NAS TRANSPORT message including an authentication message in the UUAA-SM procedure from the SMF 3. As another example, the UE 1 may receive the DL NAS TRANSPORT message including an authentication/authorization result in the UUAA-SM procedure from the SMF 3.

In step 1003, the UE 1 ignores the authentication message in the UUAA-SM procedure received in step 1002 and progresses the UE-requested PDU session release procedure. The UE 1 ignoring the authentication message may mean that the UE 1 does not perform further UUAA-SM procedures in response to the receipt of the authentication message. The UE 1 ignoring the authentication message may mean that the UE 1 suspends the proceeding of or temporarily does not perform the UUAA-SM procedure in response to the receipt of the authentication message. As another example, if the PDU session targeted in the UE-requested PDU session release procedure is a PDU session designated in the UUAA-SM procedure, the UE 1 may ignore the authentication message in the UUAA-SM procedure and progress the UE-requested PDU session release procedure. As another example, if the UE 1 receives the authentication/authorization result in step 1002, the UE 1 may ignore the authentication/authorization result and progress UE-requested PDU session release procedures. The UE 1 ignoring the authentication/authorization result may mean that the UE 1 does not perform further UUAA-SM procedures in response to the receipt of the authentication/authorization result. The UE 1 ignoring the authentication/authorization result may mean that the UE 1 suspends progress of or temporarily does not perform the UUAA-SM procedure in response to the receipt of the authentication message. As another example, if the UE 1 receives the authentication/authorization result in step 1002 and the PDU session targeted in the UE-requested PDU session release procedure is a PDU session designated in the UUAA-SM procedure, the UE 1 may ignore the authentication/authorization result in the UUAA-SM procedure and progress the UE-requested PDU session release procedures.

According to the operation shown in FIG. 10, when there is a collision between the UE-requested PDU session release procedure and the UUAA-SM procedure at the UE, the UE 1 ignores the UUAA-SM procedure and progresses the UE-requested PDU session release procedure. When there is a collision between the UE-requested PDU session release procedure and the UUAA-SM procedure at the UE, the UE 1 may prioritize to proceed with the UE-requested PDU session release procedure by ignoring the UUAA-SM procedure. Thus, even when there is a collision between the UUAA-SM procedure and the UE-requested PDU session release procedure at the UE 1, the UE 1 can handle both procedures appropriately.

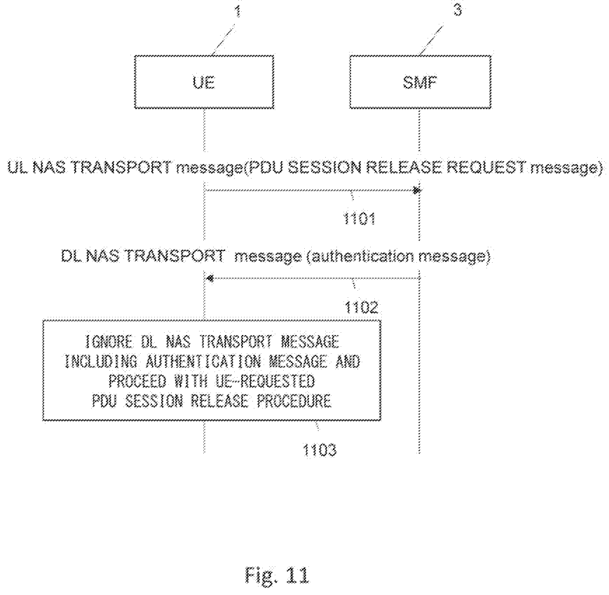

FIG. 11 shows an example of the UUAA-SM procedure during the UE-requested PDU session release procedure.

In step 1101, the UE 1 transmits the UL NAS TRANSPORT message including the PDU SESSION RELEASE REQUEST message to the SMF 3.

In step 1102, the UE 1 receives the DL NAS TRANSPORT message including the authentication message in the UUAA-SM procedure from the SMF 3. As another example, the UE 1 may receive the DL NAS TRANSPORT message including the authentication/authorization result in the UUAA-SM procedure from the SMF 3.

In step 1103, the UE 1 ignores the DL NAS TRANSPORT message including the authentication message in the UUAA-SM procedure received from the AMF 2 and proceeds with the UE-requested PDU session release procedure. As another example, if the PDU session targeted in the UE-requested PDU session release procedure is a PDU session designated in the UUAA-SM procedure, the UE 1 may ignore the DL NAS TRANSPORT message including the authentication message in the UUAA-SM procedure and proceed with the UE-requested PDU session release procedure. As another example, if the UE 1 receives the authentication/authorization result in step 1102, the UE 1 may ignore the authentication/authorization result and proceed with the UE-requested PDU session release procedure. As another example, if the UE 1 receives the authentication/authorization result in step 1102 and the PDU session targeted in the UE-requested PDU session release procedure is a PDU session designated in the UUAA-SM procedure, the UE 1 may ignore the authentication/authorization result in the UUAA-SM procedure and proceed with the UE-requested PDU session release procedure.

According to the operation shown in FIG. 11, when there is a collision between the UE-requested PDU session release procedure and the UUAA-SM procedure at the UE, the UE 1 ignores the UUAA-SM procedure and progresses the UE-requested PDU session release procedure. When there is a collision between the UE-requested PDU session release procedure and the UUAA-SM procedure at the UE, the UE 1 may prioritize to proceed with the UE-requested PDU session release procedure by ignoring the UUAA-SM procedure. Thus, even when there is a collision between the UUAA-SM procedure and the UE-requested PDU session release procedure at the UE 1, the UE 1 can handle both procedures appropriately.

### Sixth Example Embodiment

The inventors have studied and discovered various issues related to authentication and re-authorization procedures for the UAS Service. For example, if a network executes a C2 communication authorization procedure while a UE is executing a PDU session release procedure, it is not clear how the UE will handle an authentication/authorization message in the C2 communication authorization procedure from the network. In this case, there may be a collision between the PDU session release procedure and C2 communication authorization procedure at the UE, causing either or both procedures to fail.

This example embodiment provides a solution for appropriately handling a collision between the UE-requested PDU session release procedure and the C2 communication authorization procedure at the UE.

A configuration example of a cellular network according to this example embodiment may be similar to that of the example shown in FIG. 1.

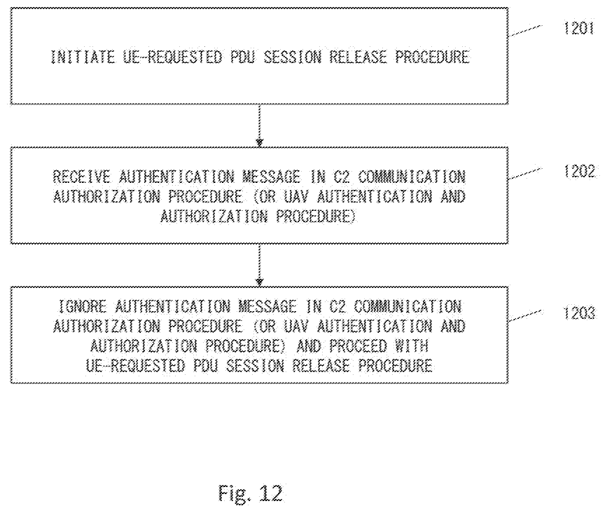

FIG. 12 is a flowchart showing an example of an operation of the UE 1 according to this example embodiment.

In step 1201, the UE 1 initiates the UE-requested PDU session release procedure. The UE 1 may initiate the UE-requested PDU session release procedure by transmitting a UL NAS TRANSPORT message including a PDU SESSION RELEASE REQUEST message to the SMF 3.

In step 1202, the UE 1 receives the DL NAS TRANSPORT message including the authentication message in the Authorization for C2 procedure from the SMF 3. As another example, the UE 1 receives the DL NAS TRANSPORT message including the authentication/authorization result in the C2 communication authorization procedure from the SMF 3. The C2 communication authorization procedure may be referred to as Authorization of C2 communication.

In step 1203, the UE 1 ignores the authentication message in the C2 communication authorization procedure received in step 1202 and proceeds with the UE-requested PDU session release procedure. The UE 1 ignoring the authentication message may mean that the UE 1 does not perform further C2 communication authorization procedures in response to the receipt of the authentication message. The UE 1 ignoring the authentication message may mean that the UE 1 suspends the proceeding of or temporarily does not perform the C2 communication authorization procedure in response to the receipt of the authentication message. As another example, if the PDU session targeted in the UE-requested PDU session release procedure is a PDU session designated in the C2 communication authorization procedure, the UE 1 may ignore the authentication message in the C2 communication authorization procedure and proceed with the UE-requested PDU session release procedure. As another example, if the UE 1 receives the authentication/authorization result in step 1202, the UE 1 may ignore the authentication/authorization result and proceed with the UE-requested PDU session release procedure. The UE 1 ignoring the authentication/authorization result may mean that the UE 1 does not perform further C2 communication authorization procedures in response to the receipt of the authentication/authorization result. The UE 1 ignoring the authentication/authorization result may mean that the UE 1 suspends the proceeding of or temporarily does not perform the C2 communication authorization procedure in response to the receipt of the authentication message. As another example, if the UE 1 receives the authentication/authorization result in step 1202 and the PDU session targeted in the UE-requested PDU session release procedure is a PDU session designated in the C2 communication authorization procedure, the UE 1 may ignore the authentication/authorization result in the UUAA-SM procedure and proceed with the UE-requested PDU session release procedure.

In this example embodiment, the C2 communication authorization procedure may be interpreted as the UAV authentication and authorization (UUAA) procedure and vice versa.

According to the operation shown in FIG. 12, when there is a collision between the UE-requested PDU session release procedure and the C2 communication authorization procedure (or the UAV authentication and authorization procedure) at the UE, the UE 1 ignores the C2 communication authorization procedure (or the UAV authentication and authorization procedure) and proceeds with the UE-requested PDU session release procedure. When there is a collision between the UE-requested PDU session release procedure and the C2 communication authorization procedure (or the UAV authentication and authorization procedure) at the UE, the UE 1 may prioritize to proceed with the UE-requested PDU session release procedure by ignoring the C2 communication authorization procedure (or the UAV authentication and authorization procedure). Thus, even when there is a collision between the C2 communication authorization procedure (or the UAV authentication and authorization procedure) and the UE-requested PDU session release procedure at the UE 1, the UE 1 can handle both procedures appropriately.

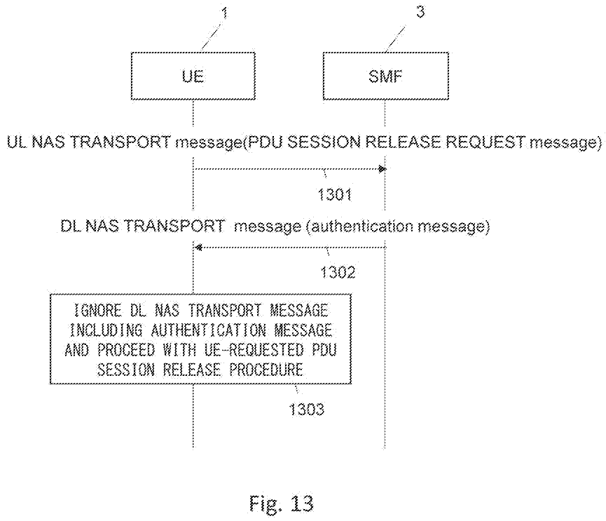

FIG. 13 shows an example of the C2 communication authorization procedure during the UE-requested PDU session release procedure.

In step 1301, the UE 1 transmits the UL NAS TRANSPORT message including the PDU SESSION RELEASE REQUEST message to the SMF 3.

In step 1302, the UE 1 receives the DL NAS TRANSPORT message including the authentication message in the C2 communication authorization procedure from the SMF 3. As another example, the UE 1 may receive the DL NAS TRANSPORT message including the authentication/authorization result in the C2 communication authorization procedure from the AMF 2.

In step 1303, the UE 1 ignores the DL NAS TRANSPORT message including the authentication message in the C2 communication authorization procedure received from the AMF 2 and proceeds with the UE-requested PDU session release procedure. As another example, if the PDU session targeted in the UE-requested PDU session release procedure is a PDU session designated in the C2 communication authorization procedure, the UE 1 may ignore the DL NAS TRANSPORT message including the authentication message in the C2 communication authorization procedure and proceed with the UE-requested PDU session release procedure. As another example, if the UE 1 receives the authentication/authorization result in step 1302, the UE 1 may ignore the authentication/authorization result and proceed with the UE-requested PDU session release procedure. As another example, if the UE 1 receives the authentication/authorization result in step 1202 and the PDU session targeted in the UE-requested PDU session release procedure is a PDU session designated in the C2 communication authorization procedure, the UE 1 may ignore the authentication/authorization result in the C2 communication authorization procedure and proceed with the UE-requested PDU session release procedure.

In this example embodiment, the C2 communication authorization procedure may be interpreted as the UAV authentication and authorization (UUAA) procedure and vice versa.

According to the operation shown in FIG. 13, when there is a collision between the UE-requested PDU session release procedure and the C2 communication authorization procedure (or the UAV authentication and authorization procedure) at the UE, the UE 1 ignores the C2 communication authorization procedure (or the UAV authentication and authorization procedure) and proceeds with the UE-requested PDU session release procedure. When there is a collision between the UE-requested PDU session release procedure and the C2 communication authorization procedure (or the UAV authentication and authorization procedure) at the UE, the UE 1 may prioritize to proceed with the UE-requested PDU session release procedure by ignoring the C2 communication authorization procedure (or the UAV authentication and authorization procedure). Thus, even when there is a collision between the C2 communication authorization procedure (or the UAV authentication and authorization procedure) and the UE-requested PDU session release procedure at the UE 1, the UE 1 can handle both procedures appropriately.

### Seventh Example Embodiment

The inventors have studied and discovered various issues related to Service-level authentication and authorization procedure (C2 communication authorization procedure). For example, it is not clear how to control the attempt of a new PDU session modification procedure or PDU session establishment procedure that triggers the C2 communication authorization procedure by the UE while the network is executing the C2 communication authorization procedure. Since the network is executing the C2 communication authorization procedure, the triggering of a new C2 communication authorization procedure creates a collision in the procedure.

This example embodiment provides a procedure to prevent the UE from executing a new PDU session modification or PDU session establishment procedure that triggers the service-level authentication and authorization procedure (C2 communication authorization procedure) until the network completes the service-level authentication and authorization procedure (C2 communication authorization procedure).

A configuration example of a cellular network according to this example embodiment may be similar to that of the example shown in FIG. 1.

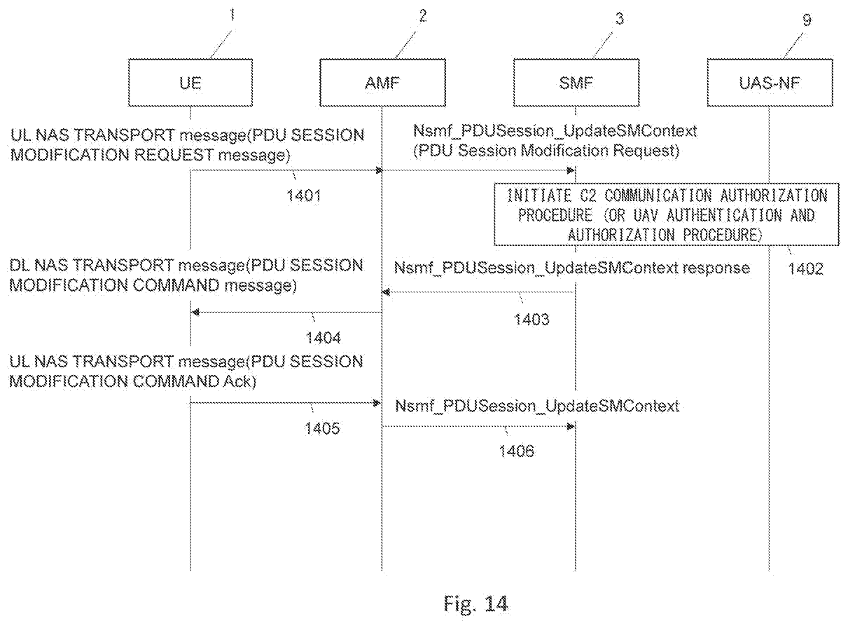

FIG. 14 shows an example during the C2 communication authorization procedure.

In step 1401, the SMF 3 receives the PDU SESSION MODIFICATION REQUEST message in the PDU session modification procedure from the UE 1 via the AMF 2.

In step 1402, the SMF 3 initiates the C2 communication authorization procedure in response to the receipt of the PDU SESSION MODIFICATION REQUEST message from the UE 1. Specifically, the SMF 3 invokes the Nnef_Auth_Reauth service operation. The existing C2 communication authorization procedure is specified in FIG. 5.2.5.2.2-1 of Non Patent Literature 4.

In step 1403, the SMF 3 transmits to the AMF 2 a Nsmf_PDUSession_UpdateSMContext Response including information indicating that the service-level authentication and authorization procedure (C2 communication authorization procedure) is in progress. The information indicating that the service-level authentication and authorization procedure (C2 communication authorization procedure) is in progress may be information indicating that the service-level authentication and authorization procedure is pending. The information indicating that the service-level authentication and authorization procedure (C2 communication authorization procedure) is in progress may be included in the service-level-AA pending indication IE.

In step 1404, the AMF 2 that has received the Nsmf_PDUSession_UpdateSMContext Response transmits to the UE 1 a PDU Session Modification Command message including information indicating that the service-level authentication and authorization procedure (C2 communication authorization procedure) is in progress.

In step 1405, the UE 1 that has received the PDU Session Modification Command message responds to the AMF 2 with a PDU Session Modification Command Ack (or PDU SESSION MODIFICATION COMPLETE message) that it has recognized that the service-level authentication and authorization procedure (C2 communication authorization procedure) is in progress.

In step 1406, the AMF 2 transmits to the SMF 3 the Nsmf_PDUSession_UpdateSMContext including information indicating that the UE 1 has recognized that the Service-level authentication and authorization procedure (C2 communication authorization procedure) is in progress. The existing PDU session modification procedure is defined in FIG. 4.3.3.2-1 of Non Patent Literature 2.

According to the operation shown in FIG. 14, the SMF 3 notifies the UE 1 of information indicating that the network is executing the service-level authentication and authorization procedure (C2 communication authorization procedure). This prevents the UE 1 from executing a new PDU session modification or PDU session establishment procedure that triggers the service-level authentication and authorization procedure (C2 communication authorization procedure) until the service-level authentication and authorization procedure is completed.

However, the UE 1 may, as an exception, be able to execute the UE-requested PDU session release procedure even during the service-level authentication and authorization procedure (C2 communication authorization procedure).

The following provides configuration examples of the UE 1, AMF 2, and SMF 3 according to the above-described example embodiments.

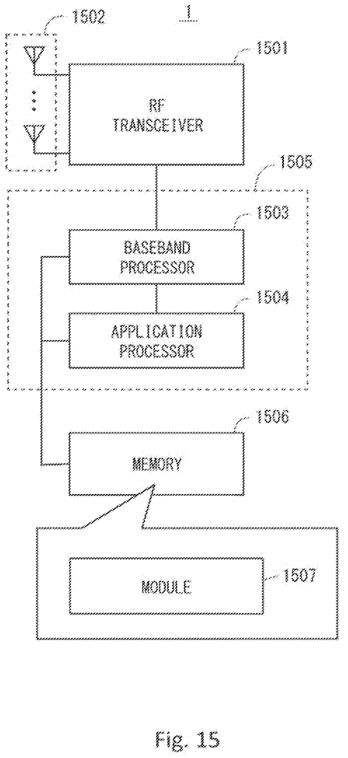

FIG. 15 is a block diagram showing a configuration example of the UE 1.

A Radio Frequency (RF) transceiver 1501 performs analog RF signal processing to communicate with NG-RAN nodes. The RF transceiver 1501 may include a plurality of transceivers. The analog RF signal processing performed by the RF transceiver 1501 includes frequency up-conversion, frequency down-conversion, and amplification. The RF transceiver 1501 is coupled to an antenna array 1502 and a baseband processor 1503. The RF transceiver 1501 receives modulated symbol data (or OFDM symbol data) from the baseband processor 1503, generates a transmission RF signal, and supplies the transmission RF signal to the antenna array 1502. Further, the RF transceiver 1501 generates a baseband reception signal based on a reception RF signal received by the antenna array 1502 and supplies the baseband reception signal to the baseband processor 1503. The RF transceiver 1501 may include an analog beamformer circuit for beam forming. The analog beamformer circuit includes, for example, a plurality of phase shifters and a plurality of power amplifiers.

The baseband processor 1503 performs digital baseband signal processing (i.e., data-plane processing) and control-plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). Meanwhile, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

The digital baseband signal processing by the baseband processor 1503 may include, for example, signal processing of a Service Data Adaptation Protocol (SDAP) layer, a Packet Data Convergence Protocol (PDCP) layer, a Radio Link Control (RLC) layer, a Medium Access Control (MAC) layer, and a Physical (PHY) layer. Further, the control-plane processing performed by the baseband processor 1503 may include processing of Non-Access Stratum (NAS) protocols, Radio Resource Control (RRC) protocols, and MAC Control Elements (CEs).

The baseband processor 1503 may perform Multiple Input Multiple Output (MIMO) encoding and pre-coding for beam forming.

The baseband processor 1503 may include a modem processor (e.g., Digital Signal Processor (DSP)) that performs the digital baseband signal processing and a protocol stack processor (e.g., a Central Processing Unit (CPU) or a Micro Processing Unit (MPU)) that performs the control-plane processing. In this case, the protocol stack processor, which performs the control-plane processing, may be integrated with an application processor 1504 described in the following.

The application processor 1504 is also referred to as a CPU, an MPU, a microprocessor, or a processor core. The application processor 1504 may include a plurality of processors (or processor cores). The application processor 1504 loads a system software program (Operating System (OS)) and various application programs (e.g., a call application, a WEB browser, a mailer, a camera operation application, and a music player application) from a memory 1506 or from another memory (not illustrated) and executes these programs, thereby providing various functions of the UE 1.

In some implementations, as represented by a dashed line (1505) in FIG. 15, the baseband processor 1503 and the application processor 1504 may be integrated on a single chip. In other words, the baseband processor 1503 and the application processor 1504 may be implemented in a single System on Chip (SoC) device 1505. An SoC device may be referred to as a Large-Scale Integration (LSI) or a chipset.

The memory 1506 is a volatile memory, a non-volatile memory, or a combination thereof. The memory 1506 may include a plurality of memory devices that are physically independent from each other. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 1506 may include, for example, an external memory device that can be accessed from the baseband processor 1503, the application processor 1504, and the SoC 1505. The memory 1506 may include an internal memory device that is integrated into the baseband processor 1503, the application processor 1504, or the SoC 1505. Further, the memory 1506 may include a memory in a Universal Integrated Circuit Card (UICC).

The memory 1506 may store one or more software modules (computer programs) 1507 including instructions and data to perform the processing by the UE 1 described in the above example embodiments. In some implementations, the baseband processor 1503 or the application processor 1504 may load these software modules 1507 from the memory 1506 and execute the loaded software modules, thereby performing the processing of the UE 1 described in the above example embodiments with reference to the drawings.

The control-plane processing and operations performed by the UE 1 described in the above example embodiments can be achieved by elements other than the RF transceiver 1501 and the antenna array 1502, i.e., achieved by the memory 1506, which stores the software modules 1507, and one or both of the baseband processor 1503 and the application processor 1504.

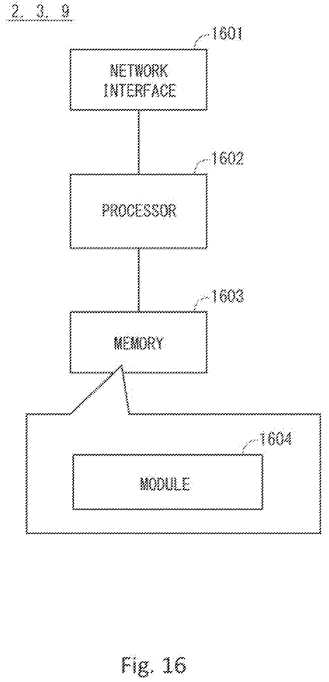

FIG. 16 shows a configuration example of the AMF 2. The SMF 3 and the UAS-NF 9 may also be configured as shown in FIG. 16. Referring to FIG. 16, the AMF 2 includes a network interface 1601, a processor 1602, and a memory 1603. The network interface 1601 is used to communicate, for example, with RAN nodes and with other network functions (NFs) or nodes in the 5GC. The other NFs or nodes in the 5GC include, for example, UDM, AUSF, UPF, DN, NSSAAF, and PCF. The network interface 1601 may include, for example, a network interface card (NIC) conforming to the IEEE 802.3 series.

The processor 1602 may be, for example, a microprocessor, a Micro Processing Unit (MPU), or a Central Processing Unit (CPU). The processor 1602 may include a plurality of processors.

The memory 1603 is composed of a volatile memory and a nonvolatile memory. The memory 1603 may include multiple memory devices that are physically independent. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 1603 may include a storage located apart from the processor 1602. In this case, the processor 1602 may access the memory 1603 via the network interface 1601 or an I/O interface (not illustrated).

The memory 1603 may store one or more software modules (computer programs) 1604 including instructions and data to perform the processing of the AMF 2 described in the above example embodiments. In some implementations, the processor 1602 may be configured to load the one or more software modules 1604 from the memory 1603 and execute the loaded software modules, thereby performing the processing of the AMF 2 described in the above example embodiments.

As described above with reference to FIGS. 15 and 16, each of the processors that the UE 1, AMF 2, SMF 3, and UAS-NF 9 according to the above example embodiments include executes one or more programs including instructions for causing a computer to execute an algorithm described with reference to the drawings. These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the programs to a computer via a wired communication line (e.g., electric wires, and optical fibers) or a wireless communication line.

The wireless terminal (User Equipment (UE)) in the present disclosure is an entity to be connected to a network via a wireless interface. It should be noted that the radio terminal (UE) in the present disclosure is not limited to a dedicated communication device, and it may be any device as follows having the communication functions herein explained.

The terms “User Equipment (UE)” (as the term is used by 3GPP), “mobile station”, “mobile terminal”, “mobile device”, and “radio terminal (wireless device)” are generally intended to be synonymous with one another. The UE may include standalone mobile stations, such as terminals, cell phones, smartphones, tablets, cellular IoT (internet of things) terminals, and IoT devices. The terms “UE” and “radio terminal” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper projecting machinery; chemical machinery; mining and/or construction machinery and/or related equipment; machinery and/or implements for agriculture, forestry and/or fisheries; safety and/or environment preservation equipment; tractors; bearings; precision bearings; chains; gears; power transmission equipment; lubricators; valves; pipe fittings; and/or application systems for any of the previously mentioned equipment or machinery, etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons, etc.).

A UE may, for example, be an item of information and communication equipment (for example information and communication equipment such as: electronic computer and related equipment; communication and related equipment; electronic components, etc.).

A UE may, for example, be an item of refrigeration equipment, a refrigeration application product and equipment, trade and/or service industry equipment, a vending machine, an automatic service machine, an office machine or equipment, a consumer electronic and electronic appliance (for example a consumer electronic appliance such as: audio equipment; a speaker; a radio; video equipment; a television; an oven range; a rice cooker; a coffee maker; a dishwasher; a washing machine; dryers, a fan, an exhaust fan and related products, a vacuum cleaner, etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment, etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag, etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies. IoT devices (or “things”) may be equipped with appropriate electronics, software, sensors, network connectivity, and/or the like, which enable these devices to collect and exchange data with each other and with other communication devices. IoT devices may include automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked. IoT technology can be implemented on any communication devices that can connect to a communications network for sending/receiving data, regardless of whether such communication devices are controlled by human input or software instructions stored in memory. IoT devices are sometimes also referred to as Machine-Type Communication (MTC) devices, Machine-to-Machine (M2M) communication devices, or Narrow Band-IoT (NB-IoT) UE.

A UE may support one or more IoT or MTC applications.

Some examples of MTC applications are listed in 3GPP TS 22.368 V13.2.0 (2017 Jan. 13), Annex B (the contents of which are incorporated herein by reference). This list is not exhaustive and is intended to be indicative of some examples of MTC applications. In this list, the Service Area of the MTC applications includes Security, Tracking & Tracing, Payment, Health, Remote Maintenance/Control, Metering, and Consumer Devices.

Examples of the MTC applications regarding Security include Surveillance systems, Backup for landline, Control of physical access (e.g., to buildings), and Car/driver security.

Examples of the MTC applications regarding Tacking & Tracing include Fleet Management, Order Management, Telematics insurance: Pay as you drive (PAYD), Asset Tracking, Navigation, Traffic information, Road tolling, and Road traffic optimisation/steering.

Examples of the MTC applications regarding Payment include Point of sales (POS), Vending machines, and Gaming machines.

Examples of the MTC applications regarding Health include Monitoring vital signs, Supporting the aged or handicapped, Web Access Telemedicine points, and Remote diagnostics.

Examples of the MTC applications regarding Remote Maintenance/Control include Sensors, Lighting, Pumps, Valves, Elevator control, Vending machine control, and Vehicle diagnostics.

Examples of the MTC applications regarding Metering include Power, Gas, Water, Heating, Grid control, and Industrial metering.

Examples of the MTC applications regarding Consumer Devices include Digital photo frames, Digital cameras, and eBooks.

Applications, services, and solutions may be an Mobile Virtual Network Operator (MVNO) service/system, an emergency radio communication service/system, a Private Branch exchange (PBX) service/system, a PHS/Digital Cordless Telecommunications service/system, a Point of sales (POS) service/system, an advertise calling service/system, a Multimedia Broadcast and Multicast Service (MBMS) service/system, a Vehicle to Everything (V2X) service/system, a train radio service/system, a location related service/system, a Disaster/Emergency Wireless Communication Service/system, an Internet of Things (IoT) service/system, a community service/system, a video streaming service/system, a femto cell application service/system, a Voice over LTE (VOLTE) service/system, a radio tag service/system, a charging service/system, a radio on demand service/system, a roaming service/system, an activity monitoring service/system, a telecom carrier/communication NW selection service/system, a functional restriction service/system, a Proof of Concept (PoC) service/system, a personal information management service/system, a display video service/system, a non-communication service/system, an ad-hoc NW/Delay Tolerant Networking (DTN) service/system, etc.

The above-described UE categories are merely examples of applications of the technical ideas and example embodiments described in the present disclosure. The UE described in this disclosure is not limited to these examples and various modifications can be made thereto by those skilled in the art.

The above-described example embodiments are merely examples of applications of the technical ideas obtained by the inventors. These technical ideas are not limited to the above-described example embodiments and various modifications can be made thereto.

The whole or part of the example embodiments disclosed above can be described as, but not limited to, the following supplementary notes.

### Supplementary Note 1-1

An Access and Mobility Management Function (AMF) node comprising:
at least one memory; and
at least one processor coupled to the at least one memory, wherein
the at least one processor is configured to:
   initiate a UAV Authentication and Authorization (UUAA-MM) procedure,
   receive a DEREGISTRATION REQUEST message in a UE-initiated de-registration procedure from an Uncrewed Aerial Vehicle (UAV),
   abort the UUAA-MM procedure in response to the receipt of the DEREGISTRATION REQUEST message, and
   proceed with the UE-initiated de-registration procedure when the AMF node receives the DEREGISTRATION REQUEST message.

### Supplementary Note 1-2

A method in an Access and Mobility Management Function (AMF) node, the method comprising:
initiating a UAV Authentication and Authorization (UUAA-MM) procedure;
receiving a DEREGISTRATION REQUEST message in a UE-initiated de-registration procedure from an Uncrewed Aerial Vehicle (UAV);
aborting the UUAA-MM procedure in response to the receipt of the DEREGISTRATION REQUEST message; and
proceeding with the UE-initiated de-registration procedure when the AMF node receives the DEREGISTRATION REQUEST message.

### Supplementary Note 1-3

A non-transitory computer readable medium storing a program for causing a computer to execute a method in an Access and Mobility Management Function (AMF) node, the method comprising:
initiating a UAV Authentication and Authorization (UUAA-MM) procedure;
receiving a DEREGISTRATION REQUEST message in a UE-initiated de-registration procedure from an Uncrewed Aerial Vehicle (UAV);
aborting the UUAA-MM procedure in response to the receipt of the DEREGISTRATION REQUEST message; and
proceeding with the UE-initiated de-registration procedure when the AMF node receives the DEREGISTRATION REQUEST message.

### Supplementary Note 2-1

An Uncrewed Aerial Vehicle (UAV) comprising:
at least one memory; and
at least one processor coupled to the at least one memory, wherein
the at least one processor is configured to:
   initiate a UE-initiated de-registration procedure,
   receive a DL NAS TRANSPORT message in a UUAA-MM procedure from an Access and Mobility Management Function (AMF) node,
   ignore the received DL NAS TRANSPORT message, and
   proceed with the UE-initiated de-registration procedure when the UAV receives the DL NAS TRANSPORT message.

### Supplementary Note 2-2

A method in an Uncrewed Aerial Vehicle (UAV), the method comprising:
initiating a UE-initiated de-registration procedure;
receiving a DL NAS TRANSPORT message in a UUAA-MM procedure from an Access and Mobility Management Function (AMF) node;
ignoring the received DL NAS TRANSPORT message; and
proceeding with the UE-initiated de-registration procedure when the UAV receives the DL NAS TRANSPORT message.

### Supplementary Note 2-3

A non-transitory computer readable medium storing a program for causing a computer to execute a method in an Uncrewed Aerial Vehicle (UAV), the method comprising:
initiating a UE-initiated de-registration procedure;
receiving a DL NAS TRANSPORT message in a UUAA-MM procedure from an Access and Mobility Management Function (AMF) node;
ignoring the received DL NAS TRANSPORT message; and
proceeding with the UE-initiated de-registration procedure when the UAV receives the DL NAS TRANSPORT message.

### Supplementary Note 3-1

A Session Management Function (SMF) node comprising:
at least one memory; and
at least one processor coupled to the at least one memory, wherein
the at least one processor is configured to:
   initiate a UAV authentication and authorization procedure for session management (UUAA-SM procedure),
   receive a PDU SESSION RELEASE REQUEST message for a PDU session providing connectivity to a UAS NF 9 in a UE-requested PDU session release procedure,
   abort the UUAA-SM procedure in response to the receipt of the PDU SESSION RELEASE REQUEST message, and
   proceed with the UE-requested PDU session release procedure when the SMF node receives the PDU SESSION RELEASE REQUEST message.

### Supplementary Note 3-2

A method in a Session Management Function (SMF) node, the method comprising:
initiating a UAV authentication and authorization procedure for session management (UUAA-SM procedure);
receiving a PDU SESSION RELEASE REQUEST message for a PDU session providing connectivity to a UAS NF 9 in a UE-requested PDU session release procedure;
aborting the UUAA-SM procedure in response to the receipt of the PDU SESSION RELEASE REQUEST message; and
proceeding with the UE-requested PDU session release procedure when the SMF node receives the PDU SESSION RELEASE REQUEST message.

### Supplementary Note 3-3

A non-transitory computer readable medium storing a program for causing a computer to execute a method in a Session Management Function (SMF) node, the method comprising:
initiating a UAV authentication and authorization procedure for session management (UUAA-SM procedure);
receiving a PDU SESSION RELEASE REQUEST message for a PDU session providing connectivity to a UAS NF 9 in a UE-requested PDU session release procedure;
aborting the UUAA-SM procedure in response to the receipt of the PDU SESSION RELEASE REQUEST message; and
proceeding with the UE-requested PDU session release procedure when the SMF node receives the PDU SESSION RELEASE REQUEST message.

### Supplementary Note 4-1

A Session Management Function (SMF) node comprising:
at least one memory; and
at least one processor coupled to the at least one memory, wherein
the at least one processor is configured to:
   initiate a C2 Communication Authorization Procedure (Authorization for C2 Procedure) or a UAV Authentication and Authorization Procedure (UUAA-SM Procedure),
   receive a PDU SESSION RELEASE REQUEST message in a UE-requested PDU session release procedure,
   abort the C2 communication authorization procedure or the UUAA-SM procedure in response to the receipt of the PDU SESSION RELEASE REQUEST message, and
   proceed with the UE-requested PDU session release procedure when the SMF node receives the PDU SESSION RELEASE REQUEST message.

### Supplementary Note 4-2

A method in a Session Management Function (SMF) node, the method comprising:
initiating a C2 Communication Authorization Procedure (Authorization for C2 Procedure) or a UAV Authentication and Authorization Procedure (UUAA-SM Procedure);
receiving a PDU SESSION RELEASE REQUEST message in a UE-requested PDU session release procedure;
aborting the C2 communication authorization procedure or the UUAA-SM procedure in response to the receipt of the PDU SESSION RELEASE REQUEST message; and
proceeding with the UE-requested PDU session release procedure when the SMF node receives the PDU SESSION RELEASE REQUEST message.

### Supplementary Note 4-3

A non-transitory computer readable medium storing a program for causing a computer to execute a method in a Session Management Function (SMF) node, the method comprising:
initiating a C2 Communication Authorization Procedure (Authorization for C2 Procedure) or a UAV Authentication and Authorization Procedure (UUAA-SM Procedure);
receiving a PDU SESSION RELEASE REQUEST message in a UE-requested PDU session release procedure;
aborting the C2 communication authorization procedure or the UUAA-SM procedure in response to the receipt of the PDU SESSION RELEASE REQUEST message; and
proceeding with the UE-requested PDU session release procedure when the SMF node receives the PDU SESSION RELEASE REQUEST message.

### Supplementary Note 5-1

An Uncrewed Aerial Vehicle (UAV) comprising:
at least one memory; and
at least one processor coupled to the at least one memory, wherein
the at least one processor is configured to:
   initiate a UE-requested PDU session release procedure,
   receive an authentication message in a UUAA-SM procedure,
   ignore the received authentication message, and
   proceed with the UE-requested PDU session release procedure when the UAV receives the authentication message.

### Supplementary Note 5-2

A method in an Uncrewed Aerial Vehicle (UAV), the method comprising:
initiating a UE-requested PDU session release procedure;
receiving an authentication message in a UUAA-SM procedure;
ignoring the received authentication message; and
proceeding with the UE-requested PDU session release procedure when the UAV receives the authentication message.

### Supplementary Note 5-3

A non-transitory computer readable medium storing a program for causing a computer to execute a method in an Uncrewed Aerial Vehicle (UAV), the method comprising:
initiating a UE-requested PDU session release procedure;
receiving an authentication message in a UUAA-SM procedure;
ignoring the received authentication message; and
proceeding with the UE-requested PDU session release procedure when the UAV receives the authentication message.

### Supplementary Note 6-1

An Uncrewed Aerial Vehicle (UAV) comprising:
at least one memory; and
at least one processor coupled to the at least one memory, wherein
the at least one processor is configured to:
   initiate a UE-requested PDU session release procedure,
   receive an authentication message in a C2 communication authorization procedure (Authorization for C2 procedure) or a UAV authentication and authorization procedure (UUAA-SM procedure),
   ignore the received authentication message, and
   proceed with the UE-requested PDU session release procedure when the UAV receives the authentication message.

### Supplementary Note 6-2

A method in an Uncrewed Aerial Vehicle (UAV), the method comprising:
initiating a UE-requested PDU session release procedure;
receiving an authentication message in a C2 communication authorization procedure (Authorization for C2 procedure) or a UAV authentication and authorization procedure (UUAA-SM procedure);
ignoring the received authentication message; and
proceeding with the UE-requested PDU session release procedure when the UAV receives the authentication message.

### Supplementary Note 6-3

A non-transitory computer readable medium storing a program for causing a computer to execute a method in an Uncrewed Aerial Vehicle (UAV), the method comprising:
initiating a UE-requested PDU session release procedure;
receiving an authentication message in a C2 communication authorization procedure (Authorization for C2 procedure) or a UAV authentication and authorization procedure (UUAA-SM procedure);
ignoring the received authentication message; and
proceeding with the UE-requested PDU session release procedure when the UAV receives the authentication message.

### Supplementary Note 7-1

An Uncrewed Aerial Vehicle (UAV) comprising:
at least one memory; and
at least one processor coupled to the at least one memory, wherein
the at least one processor is configured to:
   receive from a network a PDU Session Modification Command message including information indicating that a C2 communication authorization procedure (Service-level authentication and authorization procedure) is in progress, and
   transmit to the network a PDU Session Modification Command Ack or PDU SESSION MODIFICATION COMPLETE message including information indicating that the UAV has recognized that the Service-level authentication and authorization procedure (C2 communication authorization procedure) is in progress.

### Supplementary Note 7-2

A method in an Uncrewed Aerial Vehicle (UAV), the method comprising:
receiving from a network a PDU Session Modification Command message including information indicating that a C2 communication authorization procedure (Service-level authentication and authorization procedure) is in progress, and
transmitting to the network a PDU Session Modification Command Ack or PDU SESSION MODIFICATION COMPLETE message including information indicating that the UAV has recognized that the Service-level authentication and authorization procedure (C2 communication authorization procedure) is in progress.

### Supplementary Note 7-3

A non-transitory computer readable medium storing a program for causing a computer to execute a method in an Uncrewed Aerial Vehicle (UAV), the method comprising:
receiving from a network a PDU Session Modification Command message including information indicating that a C2 communication authorization procedure (Service-level authentication and authorization procedure) is in progress, and
transmitting to the network a PDU Session Modification Command Ack or PDU SESSION MODIFICATION COMPLETE message including information indicating that the UAV has recognized that the Service-level authentication and authorization procedure (C2 communication authorization procedure) is in progress.

This application claims the priority based on Japanese Patent Application No. 2021-160146 filed Sep. 29, 2021, disclosure of which is incorporated by reference in its entirety.

### REFERENCE SIGNS LIST

1 UE
2 AMF
3 SMF
4 AUSF
5 AN
6 UPF
7 DN
8 UDM
9 UAS NF
10 NSSAAF
1503 BASEBAND PROCESSOR
1504 APPLICATION PROCESSOR
1506 MEMORY
1507 MODULE
1602 PROCESSOR
1603 MEMORY
1604 MODULE

What is claimed is:

1. An Access and Mobility Management Function (AMF) node comprising:
at least one memory; and
at least one processor coupled to the at least one memory, wherein
the at least one processor is configured to:
initiate a UAV Authentication and Authorization (UUAA-MM) procedure,
receive a DEREGISTRATION REQUEST message in a UE-initiated de-registration procedure from an Uncrewed Aerial Vehicle (UAV),
abort a part of the UUAA-MM procedure in response to the receipt of the DEREGISTRATION REQUEST message, and
proceed with the UE-initiated de-registration procedure when the AMF node receives the DEREGISTRATION REQUEST message.

2. A method in an Access and Mobility Management Function (AMF) node, the method comprising:
initiating a UAV Authentication and Authorization (UUAA-MM) procedure;
receiving a DEREGISTRATION REQUEST message in a UE-initiated de-registration procedure from an Uncrewed Aerial Vehicle (UAV);
aborting a part of the UUAA-MM procedure in response to the receipt of the DEREGISTRATION REQUEST message; and
proceeding with the UE-initiated de-registration procedure when the AMF node receives the DEREGISTRATION REQUEST message.

3. A non-transitory computer readable medium storing a program for causing a computer to execute a method in an Access and Mobility Management Function (AMF) node, the method comprising:
initiating a UAV Authentication and Authorization (UUAA-MM) procedure;
receiving a DEREGISTRATION REQUEST message in a UE-initiated de-registration procedure from an Uncrewed Aerial Vehicle (UAV);
aborting a part of the UUAA-MM procedure in response to the receipt of the DEREGISTRATION REQUEST message; and
proceeding with the UE-initiated de-registration procedure when the AMF node receives the DEREGISTRATION REQUEST message.

4. An Uncrewed Aerial Vehicle (UAV) comprising:
at least one memory; and
at least one processor coupled to the at least one memory, wherein
the at least one processor is configured to:
execute a UAV Authentication and Authorization (UUAA-MM) procedure,
proceed with a UE-initiated de-registration procedure, wherein
a part of the UUAA-MM procedure is aborted when the UAV transmits a DEREGISTRATION REQUEST message for initiating a UE-initiated de-registration procedure to an Access and Mobility Management Function (AMF) node while the UAV is executing the UUAA-MM procedure.

5. A method in an Uncrewed Aerial Vehicle (UAV), the method comprising:
executing a UAV Authentication and Authorization (UUAA-MM) procedure,
proceeding with a UE-initiated de-registration procedure, wherein
a part of the UUAA-MM procedure is aborted when the UAV transmits a DEREGISTRATION REQUEST message for initiating a UE-initiated de-registration procedure to an Access and Mobility Management Function (AMF) node while the UAV is executing the UUAA-MM procedure.

6. A non-transitory computer readable medium storing a program for causing a computer to execute a method in an Uncrewed Aerial Vehicle (UAV), the method comprising:
executing a UAV Authentication and Authorization (UUAA-MM) procedure,
proceeding with a UE-initiated de-registration procedure when the UAV receives the DL NAS TRANSPORT message, wherein
a part of the UUAA-MM procedure is aborted when the UAV transmits a DEREGISTRATION REQUEST message for initiating a UE-initiated de-registration procedure to an Access and Mobility Management Function (AMF) node while the UAV is executing the UUAA-MM procedure.

7. A method in a Session Management Function (SMF) node, the method comprising:
initiating a UAV authentication and authorization procedure for session management (UUAA-SM procedure),
receiving a PDU SESSION RELEASE REQUEST message for a PDU session providing connectivity to a UAS NF 9 in a UE-requested PDU session release procedure,
aborting the UUAA-SM procedure in response to the receipt of the PDU SESSION RELEASE REQUEST message, and
proceeding with the UE-requested PDU session release procedure when the SMF node receives the PDU SESSION RELEASE REQUEST message.

8-9. (canceled)

10. A method in a Session Management Function (SMF) node, the method comprising:
initiating a C2 Communication Authorization Procedure (Authorization for C2 Procedure) or a UAV Authentication and Authorization Procedure (UUAA-SM Procedure),
receiving a PDU SESSION RELEASE REQUEST message in a UE-requested PDU session release procedure,
aborting the C2 communication authorization procedure or the UUAA-SM procedure in response to the receipt of the PDU SESSION RELEASE REQUEST message, and
proceeding with the UE-requested PDU session release procedure when the SMF node receives the PDU SESSION RELEASE REQUEST message.

11-12. (canceled)

13. A method in an Uncrewed Aerial Vehicle (UAV), the method comprising:
initiating a UE-requested PDU session release procedure,
receiving an authentication message in a UUAA-SM procedure,
ignoring the received authentication message, and
proceeding with the UE-requested PDU session release procedure when the UAV receives the authentication message.

14-15. (canceled)

16. A method in an Uncrewed Aerial Vehicle (UAV), the method comprising:
initiating a UE-requested PDU session release procedure,
receiving an authentication message in a C2 communication authorization procedure (Authorization for C2 procedure) or a UAV authentication and authorization procedure (UUAA-SM procedure),
ignoring the received authentication message, and
proceeding with the UE-requested PDU session release procedure when the UAV receives the authentication message.

17-18. (canceled)

19. A method in an Uncrewed Aerial Vehicle (UAV), the method comprising:
receiving from a network a PDU Session Modification Command message including information indicating that a C2 communication authorization procedure (Service-level authentication and authorization procedure) is in progress, and
transmitting to the network a PDU Session Modification Command Ack or PDU SESSION MODIFICATION COMPLETE message including information indicating that the UAV has recognized that the Service-level authentication and authorization procedure (C2 communication authorization procedure) is in progress.

20-21. (canceled)
